(19) United States
(12) Patent Application Publication
(10) Pub. No.: US 2012/0214577 A1
(43) Pub. Date: Aug. 23, 2012

(54) SMART CARD EXTENSION CLASS

(75) Inventors: Erik B. Petersen, Reno, NV (US); Jeffery S. Shepherd, Reno, NV (US); Regan J. Snyder, Reno, NV (US); Larry R. Hollibaugh, Reno, NV (US); Jelani Brandon, Las Vegas, NV (US); Kevin Higgins, Reno, NV (US); David Salls, Reno, NV (US); Warner R. Cockerille, IV, Sparks, NV (US); Marc Espin, Sparks, NV (US); Tanya McClinton, Reno, NV (US); Robyn Hylton, Reno, NV (US); Scott MacMillan, Reno, NV (US)

(73) Assignee: IGT, Reno, NV (US)

(21) Appl. No.: 13/230,502

(22) Filed: Sep. 12, 2011

Related U.S. Application Data
(63) Continuation-in-part of application No. 12/756,396, filed on Apr. 8, 2010.
Application No. 12/756,396 is a continuation-in-part of application No. 11/967,916, filed on Dec. 31, 2007.
(60) Provisional application No. 60/904,017, filed on Feb. 27, 2007.

(51) Int. Cl. A63F 9/24; A63F 13/12

(52) U.S. Cl. 463/25; 463/42

(57) ABSTRACT

Disclosed herein are techniques for facilitating communication with a smart card in communication with a gaming machine. In some implementations, a smart card interaction device may be activated. A smart card interaction device coupled with an electronic gaming machine may be identified within an operating system running at the electronic gaming machine. The smart card interaction device may be capable of facilitating communication between the electronic gaming machine and a smart card in communication with the smart card interaction device. A communication protocol interface may be initiated within the operating system. The communication protocol interface may provide a mechanism for transmitting messages between the electronic gaming machine and devices in communication with the electronic gaming machine. A first message may be transmitted via the communication protocol interface between the smart card interaction device and a first host server via a network.

### PRIORITY AND RELATED APPLICATION DATA

This application is a continuation-in-part of and claims priority to co-pending and commonly assigned U.S. patent application Ser. No. 12/756,396, Attorney Docket No. IGT1P414X1, filed on Apr. 8, 2010, entitled “SECURE SMART CARD OPERATIONS,” by Rader et al., which is a continuation-in-part of and claims priority to co-pending and commonly assigned U.S. patent application Ser. No. 11/967,916, Attorney Docket No. IGT1P414, filed on Dec. 31, 2007, entitled “METHODS AND ARCHITECTURE FOR CASHLESS SYSTEM SECURITY,” by Cunningham et al., which claims priority to U.S. Provisional Patent Application No. 60/904,017, Attorney Docket No. IGT1P414P, filed on Feb. 27, 2007, entitled “METHODS AND ARCHITECTURE FOR CASHLESS SYSTEM SECURITY,” by Cunningham et al., all of which are incorporated herein by reference in their entirety and for all purposes.

### TECHNICAL FIELD

The present disclosure relates generally to gaming devices and systems, and more specifically to security methods for gaming devices.

### BACKGROUND

There are a wide variety of associated devices that can be connected to a gaming machine such as a slot machine or video poker machine. Some examples of these devices are lights, ticket printers, card readers, speakers, bill validators, ticket readers, coin acceptors, display panels, key pads, coin hoppers and button pads. Many of these devices are built into the gaming machine or components associated with the gaming machine such as a top box which usually sits on top of the gaming machine.

Typically, utilizing a master gaming controller, the gaming machine controls various combinations of devices that allow a player to play a game on the gaming machine and also encourage game play on the gaming machine. For example, a game played on a gaming machine usually requires a player to input money or indicia of credit into the gaming machine, indicate a wager amount, and initiate a game play. These steps require the gaming machine to control input devices, including bill validators and coin acceptors, to accept money into the gaming machine and recognize user inputs from devices, including key pads and button pads, to determine the wager amount and initiate game play. After game play has been initiated, the gaming machine determines a game outcome, presents the game outcome to the player and may dispense an award of some type depending on the outcome of the game.

As technology in the gaming industry progresses, the traditional method of dispensing coins or tokens as awards for winning game outcomes is being supplemented by ticket dispensers which print ticket vouchers that may be exchanged for cash or accepted as credit of indicia in other gaming machines for additional game play. An award ticket system, which allows award ticket vouchers to be dispensed and utilized by other gaming machines, increases the operational efficiency of maintaining a gaming machine and simplifies the player pay out process. An example of an award ticket system is the EZ pay ticket system by IGT of Reno, Nev. Award ticket systems and systems using other cashless mediums, such as smart cards, are referred to as cashless systems.

Cashless systems, such as the EZ pay ticket system, provide advantages to both game players and casino operators. For example, many players find it more convenient to carry an award ticket than a large number of coins. For gaming machine operators cashless systems tend to reduce gaming machine operating costs. For example, the infrastructure needed to remove and count indicia of credit (e.g. coins, tokens, bills) from the gaming machine may be eliminated or minimized when it is replaced with a cashless system, which reduces the gaming machine operating costs. Further, coin dust, which is potentially damaging to the components of the gaming machine (e.g. electronic components) may be eliminated or minimized when coin acceptors are replaced with the cashless system.

### SUMMARY

Various implementations described or referenced herein are directed to different devices, methods, systems, and computer program products for facilitating cashless digital transactions. In some implementations, devices, methods, systems, and computer program products may be configured or designed for use in a casino environment.

In one implementation, an electronic gaming machine may be provided. The electronic gaming machine may include a user input device configured to accept user input for conducting play of a wager-based game in which one or more game outcomes can be provided responsive to a wager. The electronic gaming machine may also include a display screen configured to display video data associated with the wager-based game. The electronic gaming machine may also include one or more processors.

In some implementations, the one or more processors may be configured to cause the electronic gaming machine to identify, within an operating system running at an electronic gaming machine, a smart card interaction device coupled with the electronic gaming machine. The smart card interaction device may be capable of facilitating communication between the electronic gaming machine and a smart card in communication with the smart card interaction device.

In some implementations, the one or more processors may be configured to cause the electronic gaming machine to initiate a communication protocol interface within the operating system. The communication protocol interface may provide a mechanism for transmitting messages between the electronic gaming machine and devices in communication with the electronic gaming machine.

In some implementations, the one or more processors may be configured to cause the electronic gaming machine to transmit, via the communication protocol interface, a first message between the smart card interaction device and a first host server. The first host server may be in communication with the electronic gaming machine via a network.

### BRIEF DESCRIPTION OF THE DRAWINGS

The included drawings are for illustrative purposes and serve only to provide examples of possible structures and process steps for the disclosed inventive systems and methods for providing secure smart card communications. These drawings in no way limit any changes in form and detail that may be made to the disclosure by one skilled in the art without departing from the spirit and scope of the disclosure.

FIG. 1 shows a block diagram 100 illustrating a system for performing smart card initialization and utilization, constructed in accordance with one implementation.

FIG. 2 shows a block diagram 200 illustrating an unregistered player smart card, constructed in accordance with one implementation.

FIG. 3 shows a block diagram 300 illustrating a registered player smart card, constructed in accordance with one implementation.

FIG. 4 shows a block diagram 400 illustrating a smart card for use in a cashless gaming device, constructed in accordance with one implementation.

FIG. 5 shows a method 500 for retrieving a smart card parameter value, performed in accordance with one implementation.

FIG. 6 shows a method 600 for updating a smart card parameter value, performed in accordance with one implementation.

FIG. 7 shows a method 700 for manually transferring credit to or from a smart card, performed in accordance with one implementation.

FIG. 8 shows a method 800 for automatically transferring credit to or from a smart card, performed in accordance with one implementation.

FIG. 9 shows a method 900 for cashing out to a smart card, performed in accordance with one implementation.

FIG. 10 shows a method 1000 for protecting smart card access, performed in accordance with one implementation.

FIG. 11 shows a method 1100 for validating offline use of a smart card, performed in accordance with one implementation.

FIG. 12 shows a method 1200 for transmitting a notification regarding a blocked smart card, performed in accordance with one implementation.

FIG. 13 shows a method 1300 for cashing out a missing smart card, performed in accordance with one implementation.

FIGS. 14, 15A, and 15B shows perspective diagrams of a gaming machine 2, configured in accordance with one implementation.

FIG. 16 shows a server-based gaming network, configured in accordance with one implementation.

FIG. 17 shows a block diagram of a system architecture 1700 for facilitating smart card transactions, configured in accordance with one implementation.

FIG. 18 shows a flowchart of a method 1800 for starting a smart card interface, performed in accordance with one implementation.

FIG. 19 shows a flow diagram of a method 1900 for a smart card interface runtime, performed in accordance with one implementation.

FIG. 20A shows a message passing diagram for transmitting a message from a smart card host to a smart card, configured in accordance with one implementation.

FIG. 20B shows a message passing diagram for transmitting a message from a smart card to a smart card host, configured in accordance with one implementation.

FIG. 21 shows a message passing diagram for cashing out an Electronic Gaming Machine (EGM) credit meter of an EGM in communication with a smart card via a smart card reader at the EGM, configured in accordance with one implementation.

FIG. 22 shows a message passing diagram for cashing out a smart card, configured in accordance with one implementation.

FIG. 23 shows a message passing diagram for transferring a balance from an EGM to a smart card, configured in accordance with one implementation.

FIG. 24 shows a message passing diagram for automatically transferring a balance from a smart card to an EGM, configured in accordance with one implementation.

FIG. 25 shows a message passing diagram for transferring a balance from a smart card to an EGM, configured in accordance with one implementation.

FIG. 26 shows a message passing diagram for a failed attempt to transfer a balance from a smart card to an EGM, configured in accordance with one implementation.

### DETAILED DESCRIPTION

Applications of systems and methods according to some implementations are described in this section. These examples are being provided solely to add context and aid in the understanding of the present disclosure. It will thus be apparent to one skilled in the art that the techniques described herein may be practiced without some or all of these specific details. In other instances, well known process steps have not been described in detail in order to avoid unnecessarily obscuring the present disclosure. Other applications are possible, such that the following examples should not be taken as definitive or limiting either in scope or setting.

In the following detailed description, references are made to the accompanying drawings, which form a part of the description and in which are shown, by way of illustration, specific implementations of the present disclosure. Although these implementations are described in sufficient detail to enable one skilled in the art to practice the disclosure, it is understood that these examples are not limiting, such that other implementations may be used and changes may be made without departing from the spirit and scope of the disclosure.

Although the present disclosure is directed primarily to gaming machines and systems, it is worth noting that some of the apparatuses, systems and methods disclosed herein might be adaptable for use in other types of devices, systems or environments, as applicable, such that their use is not restricted exclusively to gaming machines and contexts. Such other adaptations may become readily apparent upon review of the inventive apparatuses, systems and methods illustrated and discussed herein.

In the following figures, method and apparatus applicable to various gaming system configurations and their associated components are described. The gaming systems may comprise a network infrastructure for enabling one or more hosts to communicate with gaming machines. The gaming machines may be operable to provide wagering on a game of chance. A plurality of gaming devices, such as bill/ticket validators, printers, mechanical displays, video displays, coin hoppers, light panels, input buttons, touch screens, key pads, card readers, audio output devices, etc., may be coupled to the gaming machine. The gaming devices may be controlled by a master gaming controller executing authenticated software to provide a gaming interface for a game play experience on the gaming machine.

In some implementations, a smart card includes one or more programs (e.g., Java applets), which may allow both flexibility and control over the functions of the card as well as the information stored thereon. According to conventional techniques (e.g., in the Gemplus model), a credit balance is a stored value on the smart card, and an external system, such as a card reader, determines whether to alter the stored balance values to complete a transaction. A Gemplus card may determine whether a request to alter a stored balance is properly encrypted, but it does not determine whether the requester has authorization to make such a request. In contrast, some implementations include a smart card with a program residing on the card itself (e.g., a Java applet) that may verify authorization to perform the transactions. Thus, in some implementations, an external system requests the card itself to perform a transaction, and only the program on the smart card is permitted to alter the stored credit balance value.

In some implementations, running a verification application on the card itself instead of a different device eliminates the weak link in the security, described above. One reason for the increased security is that when using conventional techniques (e.g., the Gemplus model), it may be possible to physically intercept communications passing between the card and the system operating on data stored on the card. This interception often occurs at the card read/write interface of the card reader. However, when implementations disclosed herein are implemented, the operations of an application reading and/or updating the stored data often cannot be observed, and communications between the application and the data cannot be intercepted, because the application that operates on the data may be embedded within the card itself.

Another reason for the increased security is that in some implementations, the smart card itself verifies whether a requester has permission to make a request to perform a transaction, and those transactions may later be verified before allowing credit stored on the card to be given to a user as cash. This chain of trust provides increased security, as well as allowing expanded capabilities. For example, the ability to add value to a smart card need not be limited to a few trusted systems, but rather can extend to various devices in a cashless transaction system that can at least periodically communicate with a cashless server or host systems. As another example, devices may communicate with a smart card using public key encryption, so the private key associated with the smart card is not known to other devices. Since different smart cards may have different private keys, the discovery of a cryptographic key associated with one smart card will not compromise use of other smart cards.

In addition, some implementations are not limited to proprietary smart card hardware or memory sizes. Thus, the costs for each smart card according to the techniques disclosed herein may be significantly reduced as compared to traditional techniques. Further, smart cards need not be limited to a three byte purse.

In some implementations, a smart card may communicate with a smart card reader, which is also referred to herein as a smart card interaction device. The smart card interaction device may communicate with an EGM via various communication channels.

In some implementations, the smart card interaction device may communicate with the EGM software via a specialized hardware device, such as a slot machine interface board (SMIB). The SMIB may provide specialized functions, such as player tracking, that are at least partially separated from game play. The SMIB may include or communicate with user input devices that provide access to smart card functionality, such as balance transfers. However, channeling communication between a smart card interaction device and the EGM through a specialized hardware device may in some instances have one or more drawbacks. For example, adding support for new types of smart card interaction devices may require software, hardware, or firmware updates to the specialized hardware. As another example, the specialized hardware device may include proprietary hardware or software, thus potentially limiting the types of smart card interact devices that can be used in conjunction with the EGM. As yet another example, the specialized hardware device may not provide some details of smart card transactions, such as the source of transferred funds, to the EGM.

In some implementations, the smart card interaction device may communicate with the EGM software via a standard communication protocol. Electronic gaming machines (EGMs) often communicate via a standard communication protocol such as the Slot Accounting System (SAS), System-to-System (S2S), Gaming Device Standard (GDS), Best of Breed (BOB), British Amusement Catering Trade Association (BACTA), Queensland Local Area EGM Communications Protocol (QCOM), Game-to-System (G2S), or others. Using such a communication protocol, an EGM may communicate with a host server, a device coupled with the EGM, a device in communication with the EGM via a network interface, or another EGM. Communication between the EGM and a smart card interaction device via such a communication protocol may be facilitated by the addition of an extension class to the software providing access to the communication protocol. For example, when the communication protocol is loaded within the EGM operating system, an extension class providing instructions as to transmitting and receiving messages related to smart card communications may also be loaded. Such a system may allow the EGM to act as a gateway between a smart card and a host server via a network.

In some implementations, routing communications between a smart card interaction device and the EGM software directly through a standardized communication protocol may simplify the procedure for adding new types of smart card interaction devices. Instead of updating proprietary hardware or software, the existing device drivers on the EGM may be supplemented with a new device driver for the new smart card interaction device. By easily facilitating the addition of new types of smart card interaction devices, the system may be made to readily adapt to new smart card form factors and communication technologies.

In some implementations, routing communications between a smart card interaction device and the EGM software directly through a standardized communication protocol may allow the EGM to obtain additional information from the smart card interaction device, such as an identification of the source of funds transferred to the EGM. Having access to funds transfer source information may allow the EGM to maintain separate meters for different types of funds, such as cashable funds, cashable promotional funds, and non-cashable promotional funds. These different types of funds may be subject to different gaming-related regulations or accounting procedures. For example, cashable funds may be funds that belong to the player and have no special accounting requirements. As another example, cashable promotional funds may be funds given to the player that may be directly converted to cash. In some jurisdictions, a casino may get a tax benefit if they can show that the credits were played, but the patron may not be required to play them. As yet another example, non-cashable promotional funds may be funds given to the player that must be played and cannot be directly converted to cash. The additional information provided regarding these funds may facilitate improved reconciliation of accounting records in the event of discrepancies between server, EGM, and smart card transaction logs.

In some implementations, routing communications between a smart card interaction device and the EGM software directly through a standardized communication protocol may facilitate user input for smart card interaction via various mechanisms. For example, because smart card communications are routed through the EGM, the EGM gaming software may provide access to smart card functionality. As another example, access to smart card functionality may be provided via user interface devices such as a display screen, button panel, or touch screen panel connected directly with the gaming machine. As yet another example, access to smart card functionality may be provided via an externally-controlled interface (ECI) that is provided at the EGM but controlled at least in part by a remote server or other remote device.

In some implementations, changing a value or configuration parameter on a smart card may include one or more of the following operations: a system may read one or more parameter(s) stored on a smart card, an application on the smart card (e.g., a Patron Management module and/or applet) may call a function on the application to make a change, the application may validate one or more permissions and/or rules, the application may make one or more changes to the card, a player may specify an amount of money to move to and/or from the card, and/or the appropriate money may be moved to an Electronic Gaming Machine (EGM) when the card is inserted into the EGM and after checking one or more configuration values and/or performing one or more security validations, etc.

In some implementations, applications running on the EGM may perform specific operations. For example, an application may run on the EGM that automatically triggers a transaction which seeks to replenish funds when a given balance falls below a specified threshold. Such an application may include one or more of the following operations: the EGM may read one or more parameter(s) stored on a smart card; an application on the smart card (e.g., a Patron Management module and/or applet) may call a function on the application to make a change; the application may validate one or more permissions and/or rules; the application may make one or more changes to the card; a player may specify a credit threshold balance that may trigger an automatic transfer; and/or the appropriate amount of cash and/or credit may be moved when the card is inserted into an EGM, when the configuration value is checked, after one or more credit balances on the EGM are below the specified balance threshold, and/or after performing one or more security validations.

In some implementations, running one or more applications on a smart card may guard against attempts by unauthorized individuals to access an account. For example, one or more applications on a smart card may perform one or more of the following operations: attempt to validate security if a connection is made to the card; update a record of invalid access attempts if the attempt to validate security is unsuccessful; compare the record of invalid access attempts against a pre-defined limit; make the cashless gaming system aware of one or more illegal access attempts; and/or render the card useless if the number of invalid access attempts exceeds the pre-defined limit. In some implementations, information can be retrieved from a smart card but the applications can no longer change any information once the smart card is rendered useless.

In some implementations, techniques disclosed herein may permit cashing out even when a smart card is not in communication with a gaming machine (i.e. no-card cashout). Such techniques may include one or more of the following operations: receiving a request to cash out; determining whether a valid smart card is inserted; transferring credit and/or cash to the card if a valid smart card is present; transferring money from the EGM (e.g., to a Slot Machine Interface Board (SMIB)) if a valid smart card is not present; holding the cash and/or credit in non-volatile memory (e.g., in the SMIB); putting the EGM out of service; sending a notification of a no card cash out; receiving a valid smart card (e.g., a new card brought by a casino attendant); checking security and/or validating the smart card; moving cash and/or credit to the received smart card; putting the EGM back into service.

Thus, in some implementations, the present disclosure describes techniques that may offer a more secure and flexible smart card design than currently exists. It should be noted that although some techniques may be described in reference to wager-based gaming in a casino environment, these techniques are not limited to gaming but may be applicable to any or all applications and/or industries involving smart cards. Even in the gaming context, one or more techniques described herein may be used to facilitate other cashless transactions in a casino environment, such as payment for meals, hotel rooms, or other gaming-related expenditures.

Specific details related to techniques for smart card operations and/or cashless gaming in a gaming environment are discussed in U.S. Pat. No. 6,852,031, “EZ Pay Smart Card and Tickets System,” by Richard Rowe, filed on Nov. 22, 2000, and U.S. Pat. No. 5,902,983, “Preset Amount Electronic Funds Transfer System for Gaming Machines,” by Crevelt et al., filed on Apr. 29, 1996, both of which are hereby incorporated by reference for all purposes.

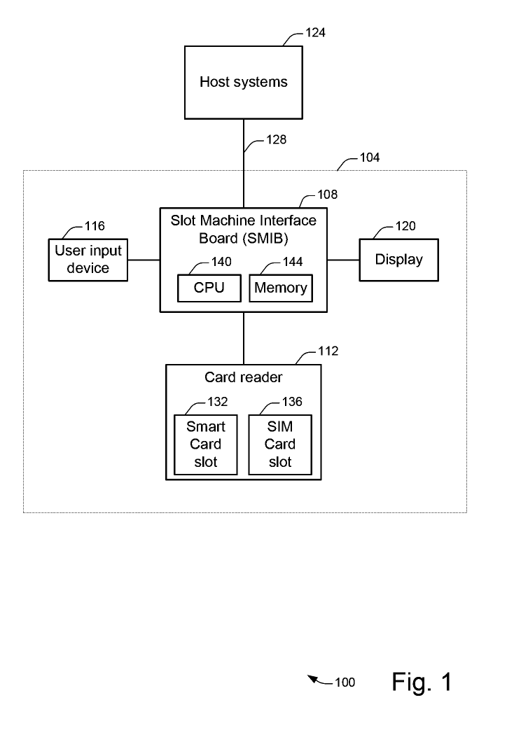

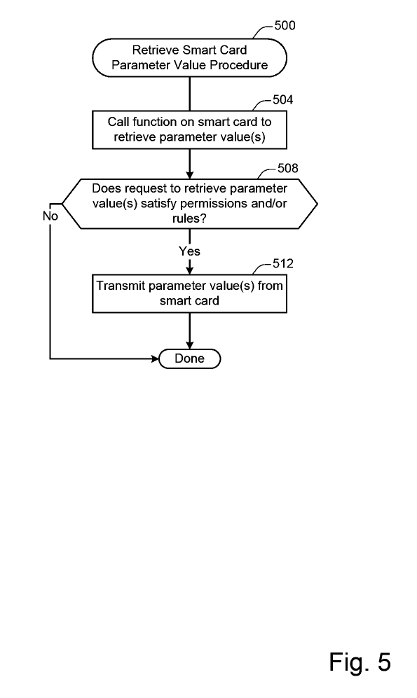

FIG. 1 shows a block diagram illustrating cashless gaming system 100, which includes system components associated with smart card initialization and/or utilization. According to various implementations, cashless gaming system 100 may be operable to perform one or more operations relating to cashless gaming, such as one or more operations described herein with reference to FIGS. 5-13. In some implementations, cashless gaming system 100 may be operable to perform one or more operations related to security validation and/or verification procedures, such as those discussed in U.S. patent application Ser. No. 11/967,916, which has been incorporated by reference.

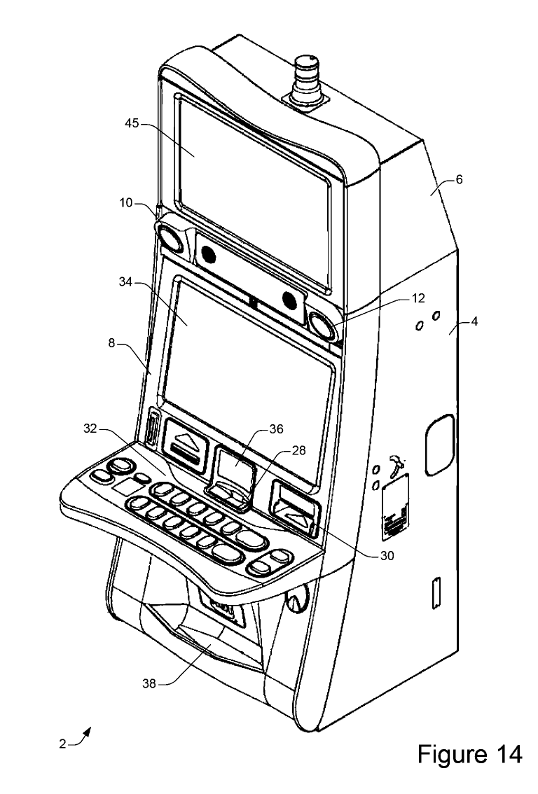

Cashless gaming system 100 includes gaming apparatus 104. In the implementation of FIG. 1, gaming apparatus 104 is a gaming machine. Additional details regarding gaming machines are discussed herein, and specifically with respect to FIG. 14. However, according to various implementations, different types of gaming apparatuses may include one or more components related to cashless gaming. For example, in different implementations gaming apparatus 104 may instead be a bank of gaming machines, a kiosk, a cashier's terminal, a patron management terminal, a card initialization terminal, or one or more other devices.

Gaming apparatus 104 includes a slot machine interface board (SMIB) 108. An example of a SMIB according to some implementations is the Bonus Engine® available from IGT of Reno, Nev. However, it should be noted that although gaming machine 104 includes a SMIB, different implementations may include one or more different control components configured to perform similar operations as SMIB 108. For example, if gaming apparatus 104 were a kiosk or a patron management system, rather than a gaming machine, a different device may be used in addition to or instead of a SMIB. In some implementations, a patron management system or cashier client may include a card reader device such as an Omnikey 3821 device or an Omnikey 3121 device, both available from HID of Walluf, Germany. Such a device may read a smart card having any one of various form factors, such as a Subscriber Identity Module (SIM) form factor. In some implementations, an EGM may include a control function that performs some or all of the functions that may otherwise be performed by the SMIB.

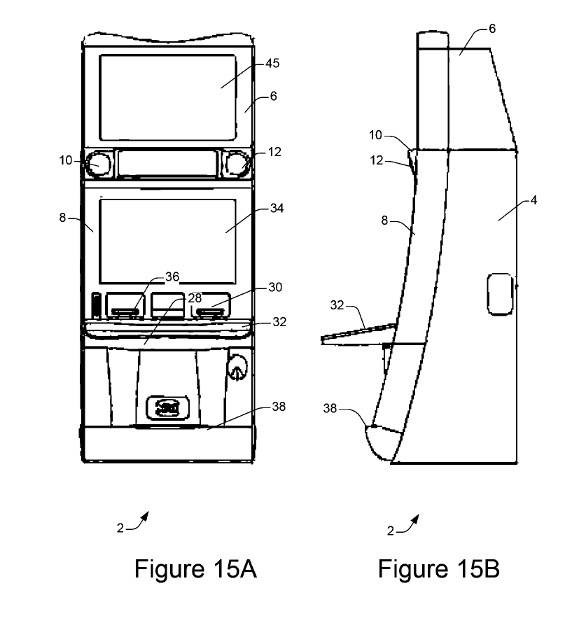

SMIB 108 includes CPU 140 and memory 144. The SMIB is in communication with other components in the gaming apparatus 104, such as a card reader 112, a user input device 116, and a display 120. In some implementations, the SMIB may communicate with these devices, and/or other devices not illustrated in FIG. 1, via one or more serial links. However, according to different implementations, one or more different types of communication links may be used. In some implementations, the SMIB 108 may communication with one or more remote devices, such as host systems 124, via a communication link 128. In some implementations, communication link 128 is a network link in a gaming network. Additional details related to gaming networks are discussed throughout the specification, and particularly with respect to FIGS. 15 and 16. In some implementations, the communication link 128 may include one or more of an Internet link, a satellite link, a wireless link, etc.

In some implementations, the SMIB may be configured or designed to control one or more components in the gaming apparatus, such as the card reader 112, the user input device 116, and/or the display 120. In addition, or alternately, the SMIB may be operable to communicate with one or more different components at the gaming apparatus not illustrated in FIG. 1. For example, the SMIB 108 may communicate with one or more components of the gaming machine, such as a master gaming controller, a display device, a service window, etc. As another example, a SMIB, STM, and/or other component associated with the cashless gaming system may communicate with one or more different types of devices or interfaces, such as a motherboard, a controller, a network interface, a service window, a kiosk (e.g., a system having a ticketing interface), a display device (e.g., a vacuum fluorescent display, a NexGen™ or sbNexGen™ available from IGT, etc.), or any other type of device.

Some implementations of the cashless gaming system may be configured for use in systems that are not under the control of the casino. One such use may be a point-of-sale interface in which a smart card reader and STM is installed in one or more stores, restaurants, hotel facilities (e.g., service desks, cafes, gift shops), or other commercial locations. Such a configuration may allow a player to use the smart card to pay for non-gaming goods or services. A smart card configured for use in such a system may include more than one purse (i.e. credit balance). The use of more than one purse may allow a casino to provide different types of credit on a smart card (e.g., gambling credits, cash, promotional dollars, bonus points, loyalty points, etc.) and/or avoid co-mingling gaming and non-gaming funds (e.g., for regulatory compliance).

As stated herein, the SMIB includes memory 144. In some implementations, memory 144 may include program instructions for CPU 140, such as program instructions relating to performing one or more operations for cashless gaming. In some implementations, memory 144 may store one or more parameter values related to cashless gaming. For example, memory 144 may store a credit balance for transfer between gaming apparatus 108 and a smart card, such as a smart card in communication with smart card slot 132. In some implementations, memory 144 is non-volatile memory. Thus, in the event of a system reset, a credit value stored on memory 144 may be maintained in event of a system failure, loss of power, and/or reset.

In some implementations, the SMIB may function according to a Transaction Complete model in which activity is not recorded to a transaction record until the transaction is completed on the smart card. Thus, if a transaction is interrupted before it can be completed (e.g., by power loss), the partially completed transaction may not be recorded in the cashless gaming system. The Transaction Complete model may thus prevent cash from being lost (e.g., transferred from an STM but not recorded on a smart card) or duplicated (e.g., transferred to a smart card but not removed from an STM).

A card reader 112 is illustrated in FIG. 1. Card reader 112 may be operable to communicate with slot machine interface board 108. According to different implementations, the card reader 112 may include one or more communication interfaces for communicating with one or more portable electronic devices. For example, the card reader 112 includes a smart card slot 132 and a SIM card slot 136. However, according to different implementations various numbers, types, and/or combinations of communication interfaces may be used.

In FIG. 1, reference numeral 132 denotes a smart card slot. Smart card slot 132 may be operable to communicate with a portable electronic device, such as a smart card. In some implementations, a smart card slot may be a physical slot into which a smart card may be inserted. Alternately, or additionally, the smart card slot 132 may be a wireless communication interface configured to communicate wirelessly with a smart card and/or a different type of portable electronic device.

In some implementations, the card reader 112 may communicate with one or more portable electronic devices operable to store a credit balance for cashless gaming. For example, the card reader 112 may communicate with a smart card via smart card slot 132. In such implementations, smart card slot 132 may be positioned so as to be accessible to a user of gaming apparatus 104. For example, smart card slot 132 may include a physical slot on the external surface on the gaming apparatus 104.

Reference numeral 136 denotes a SIM card slot. In some implementations, SIM card slot 136 may be configured to communicate with a portable electronic device, such as a smart card designed or configured in accordance with one or more of the Subscriber Identity Model (SIM) card form factors. As with the smart card slot 132, the SIM card slot 136 may be a physical slot, a wireless communication interface configured to communicate wirelessly with a SIM card or other portable electronic device, or any other type of communication interface.

In some implementations, the card reader 112 may communicate with one or more portable electronic devices operable to facilitate communications/security functions, such as a Secure Transaction Module (STM) card. For example, the card reader 112 may communicate with a STM card embodied in a SIM card format via the SIM card slot 136. In some implementations, the STM card may perform one or more encryption, decryption, and/or security validation operations associated with communications between a smart card and the gaming apparatus 104. For example, the STM card may encrypt communications transmitted from the SMIB 108 to a smart card. As another example, the STM card may decrypt communications transmitted from the smart card to the gaming apparatus 104.

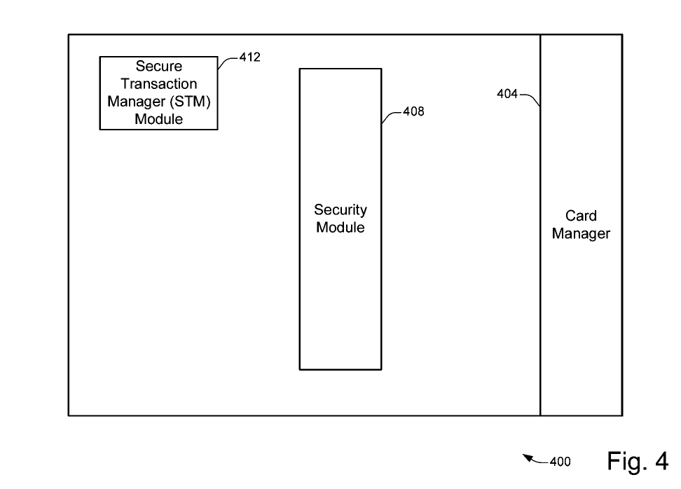

In some implementations, using an STM card for securing communications between the gaming apparatus 104 and a smart card may have one or more advantages. For example, it may be easy to add and/or remove the STM card from the gaming apparatus 104. Thus, the STM card could be easily replaced with a different STM card. As another example, security operations may be performed independent of other functions of the gaming machine and/or SMIB. As yet another example, the STM card may be preconfigured to perform one or more operations specific to one or more specific types of gaming apparatuses. Additional details regarding STM cards are discussed in relation to FIG. 4.

In some implementations (e.g., some implementations in which card reader 112 is operable to communicate with a STM card via the SIM card slot 136), the gaming apparatus 104 may include one or more security features for protecting access to SIM card slot 136. In some implementations, the card reader 112 may be configured or designed such that SIM card slot 136 is hidden from a user during the normal course of operation of gaming machine 104. For example, card reader 112 may be configured or designed such that in order to add or remove a card from SIM card slot 136, the door of the gaming machine must be opened. As another example, unauthorized access to the SIM card slot 136 may require one or more digital and/or physical keys, trigger an audible and/or silent alarm, etc.

Although an implementation of the card reader 112 illustrated in FIG. 1 is described as communicating with an STM card via SIM card slot 136 and communicating with a player's smart card via smart card slot 132, different implementations may include different configurations. For example, according to different implementations, either or both the player's smart card and the STM card may be embodied in one or more smart card formats, SIM card formats, or any other type of format for a portable electronic device. As another example, in some implementations, an STM card may be physically coupled with a gaming apparatus such that the card communicates with one or more components of the gaming apparatus without communicating via a removable slot. For example, the STM card may be a hardware and/or software component coupled with one or more components of the gaming apparatus and configured via an interface on the gaming apparatus (e.g., over a network, via a user interface, using a remote device, etc.).

In FIG. 1, reference numeral 116 denotes a user input device. According to various implementations, the user input device 116 may be any input device configured or designed to receive user input. For example, the user input device 116 may be a touch pad, a touch screen, a keypad, a keyboard, a button panel, etc.

In some implementations, the user input device may receive user input related to cashless gaming. For example, the user input device may receive a request to move cash and/or credit between the gaming apparatus and a portable electronic device in communication with the card reader 112 (e.g., a smart card in communication with smart card slot 132. As another example, the user input device may receive a request to update one or more parameter values on a smart card in communication with the card reader 112 (e.g., an updated player name, preferred language, auto-transfer threshold value, auto-transfer amount, etc.).

Reference numeral 120 denotes a display. According to various implementations, different types of displays may be used. For example, the display 120 may be an LCD, an LED display, a plasma display, a seven-segment display, etc. In some implementations, user input device 116 and display 120 may be part of the same device (e.g., a touch screen display).

The display 120 may be operable to display information related to cashless gaming. For example, the display 120 may show one or more parameter values stored on a portable electronic device in communication with card reader 112, such as one or more parameter values (e.g., player names, preferred languages, auto-transfer amounts, auto-transfer thresholds, credit balances, etc.) stored on a smart card in communication with smart card slot 132. In some implementations, the display 120 may show options for modifying one or more values on a portable electronic device in communication with smart card slot 132 (e.g., a list of possible preferred languages, a selection of approved auto-transfer threshold values, a selection of approved auto-transfer amounts, etc.).

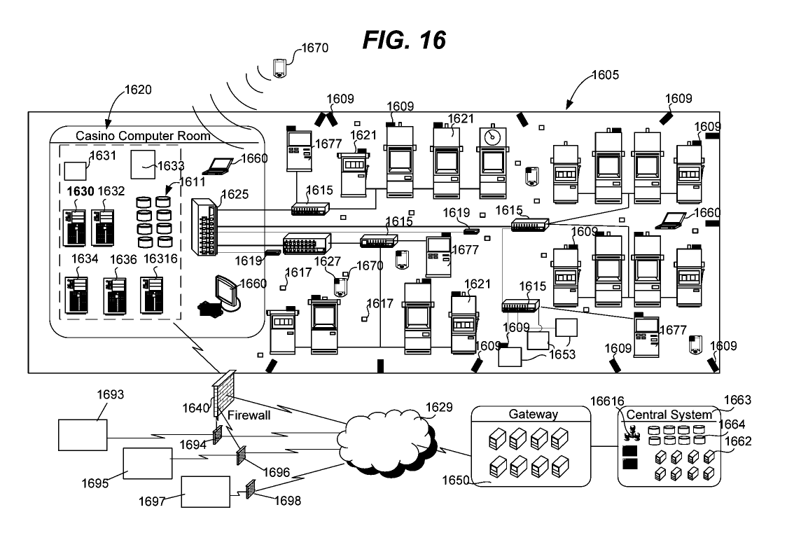

In FIG. 1, reference numeral 124 denotes host systems. Host systems 124 may include one or more servers related to cashless gaming. Slot machine interface board 108 and host systems 124 may be configured to communicate via one or more network links, such as network link 128. In some implementations, network link 128 may be a network link in a gaming network at a casino. Further details of a gaming network will be discussed in relation to FIG. 17. However, according to different implementations, network link 128 may include one or more communication links in a public network, such as the internet.

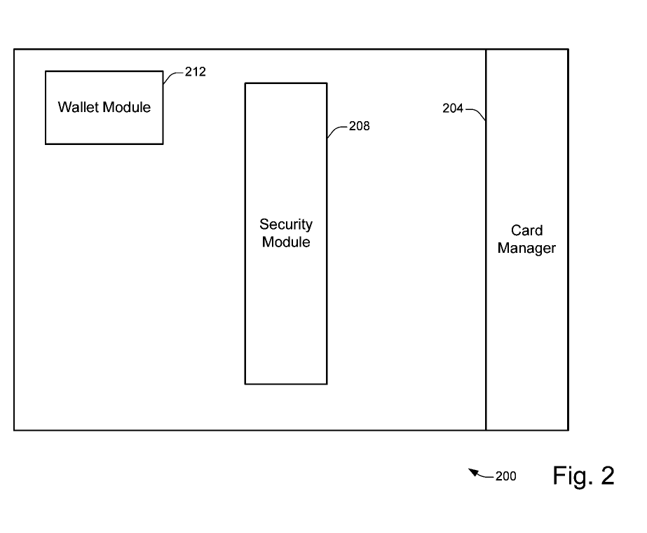

Examples of the types of portable electronic devices that may communicate with one or more components of the gaming apparatus 104 via the smart card reader 132 and/or SIM card slot 136 are smart cards 200, 300, and 400 shown in FIGS. 2, 3 and 4. Smart cards 200, 300, and 400 are portable electronic devices that each have memory and one or more processors. In addition, smart cards 200, 300, and 400 are each operable to communicate with one or more other devices in a cashless gaming system and/or casino environment.

Smart cards 200, 300, and 400 are Java smart cards designed to execute one or more programs, applications, and/or applets written in the Java programming language. However, according to different implementations, various types of programming languages may be used for various components in the cashless gaming system, such as C, C++, C#, .Net, etc. In addition, according to various implementations one or more of smart cards 200, 300, and/or 400 may be embodied in various shapes or form factors. For example, a smart card may be embodied in a SIM card, a credit card sized smart card, or any other type of portable electronic device.

FIG. 2 shows a smart card 200 that is configured or designed for use by one or more players in a casino environment, in accordance with one implementation. Smart card 200 is an unregistered smart card (e.g., a “day use” smart card) that does not include personal identification information (e.g., name, identification number, and/or is not tied to a particular user.

In some implementations, the unregistered smart card 200 is operable to communicate with one or more other devices in a gaming network by being placed in a smart card slot, such as the smart card slot 132. However, in different implementations, smart cards may communicate using one or more different techniques, for example communication via a SIM card slot (e.g., SIM card slot 136) and/or wireless communication.

Unregistered smart card 200 may include one or more hardware and/or software modules for performing functions related to cashless gaming. Each module may include data and/or program instructions. In some implementations, one or more modules may be preloaded on the unregistered smart card 200 when the smart card is constructed. In addition, or alternately, one or more modules may be configured and/or loaded on the unregistered smart card 200 via a device in a casino environment such as a gaming machine. Unregistered smart card 200 includes a card manager 204, a security module 208, and a wallet module 212.

The card manager 204 is a hardware and/or software module that includes data and/or program instructions for accessing one or more features on the unregistered smart card 200. In some implementations, the card manager 204 comes preconfigured on new smart cards. However, in different implementations, the card manager 204 may be added and/or configured by one or more devices in a cashless gaming system.

The card manager 204 may include identification information specific to the individual unregistered smart card 200, such as a smart card serial number. In some implementations, the smart card manager 204 may include one or more cryptographic access keys and/or cryptograms for accessing the unregistered smart card 200. For example, card manager 204 may include standard keys that are loaded on the smart card during construction.

In some implementations, at least some information stored in smart card manager 204 may be unalterable. For example, it may be impossible to alter the smart card serial number and/or one or more cryptographic access keys without rendering the smart card inoperable. Alternately, or additionally, it may be possible to alter one or more of the values (e.g., with appropriate security verification).

According to various implementations, card manager 204 may permit adding, removing and/or configuring other modules on the smart card. For example, card manager 204 may permit adding, removing, and/or configuring security module 208 and/or wallet module 212.

The security module 208 is a hardware and/or software module that includes data and/or program instructions for performing one or more functions related to access control and/or security verification. For example, the unregistered smart card 200 may receive one or more requests to read and/or update one or more values stored in the memory of the unregistered smart card 200. In some implementations, some or all requests to access and/or update values must be validated by the security module 208 before being performed by one or more modules on the smart card.

Thus, in some implementations, the security module 208 may include one or more pieces of information related to authenticating request to access the unregistered smart card 200. For example, the security module 208 may include a Personal Identification Number (PIN) and/or one more cryptographic keys for enabling secure communication. In addition, the security module 208 may store information relating to one or more previous transactions, previous authorizations of the smart card, transaction counts, serial numbers (e.g., a unique serial number associated with the smart card), etc. The different values stored on the smart card (e.g., in the security module) may alternately be user-configurable, configurable by the casino, or not configurable (e.g., a card serial number). In some implementations, values configurable by a casino may be updated when a card is accessed at an STM device. In this way, a casino may push out new parameter values to be stored on smart cards upon their next use.

In addition, in some implementations, the security module 208 may include program instructions for authenticating one or more requests to access the unregistered smart card 200. For example, the security module 208 may include program instructions for performing one or more functions related to secure cryptographic communications. In addition, the security module 208 may include program instructions for verifying that the sender of a request to access one or more values on the unregistered smart card 200 has the appropriate security permissions for performing said access.

The wallet module 212 is a hardware and/or software module that includes data and/or program instructions for performing one or more operations related to storing and/or transferring cash and/or credit values for cashless gaming. For example, the wallet module may be configured to store one or more credit balances. A credit balance may be an amount of credit and/or cash available for use in gambling in a casino environment. The wallet module 212 may also include program instructions for one or more programs related to adding and/or removing credit from the wallet module 212.

In some implementations, the wallet module 212 may be configured or designed to store one or more parameter values related to adding and/or removing credits stored on the wallet module. For example, the wallet module may store one or more auto-transfer threshold values. An auto-transfer threshold value may be used to determine when to automatically transfer additional credit from the smart card (e.g., credit stored in the wallet module 212) to a gaming machine. When the unregistered smart card 200 is in communication with the gaming machine, a determination may be made as to whether one or more credit balances on the gaming machine (e.g., for playing a game of chance) has dropped below the auto-transfer threshold value stored on the wallet module. If the credit balance on the gaming machine is less than the auto-transfer threshold value on the wallet module, additional credit may be moved from the smart card to the gaming machine.

As another example, the wallet module 212 may be configured to store one or more auto-transfer amounts. When credit is automatically transferred from the wallet module 212 to a gaming machine, the amount of credit may be determined in accordance with the auto-transfer threshold value. According to different implementations, different techniques for determining the amount of credit may be used. For example, the amount of credit transferred from the smart card to the gaming machine may be determined so as to raise the balance on the gaming machine to the sum of the auto-transfer threshold value and the auto-transfer threshold amount. Alternately, the amount of credit transferred from the smart card to the gaming machine may be substantially equal to the auto-transfer threshold amount.

According to various implementations, various techniques may be used to add and/or modify one or more parameter values stored on the unregistered smart card 200. In some implementations, one or more parameter values may be determined and/or stored on the smart card upon initialization of the card (e.g., at an initialization terminal), at a cashier's terminal, at a kiosk, at a patron management terminal, at a gaming machine, etc. In some implementations, permission to change one or more values stored on the smart card may be limited to one or more specific types of gaming apparatuses. For example, a casino may require supervision by casino personnel in order to change the auto-transfer threshold value and/or auto-transfer amount, since setting these values too low may in some instances cause excessive credit transfers during game play and/or excessive wear and tear on the card. Alternately, a casino may provide a range of preapproved values and/or permit card users to change one or more values without supervision (e.g., at a gaming machine, kiosk, etc.).

In some implementations, a casino may restrict the values that may be used as the auto-transfer threshold value and/or auto-transfer amount so as to reduce excessive wear at the smart card and/or to impose operational limits on credit transfers. For example, a casino may impose a maximum auto-transfer amount of $10,000 in a High Limit gaming room and a maximum auto-transfer amount of $100 on the main floor. Such game-specific or area-specific restrictions may prevent a player from transferring an excessive amount of credit to a low-denomination gaming machine (e.g., $5,000 transferred to a $0.25 slot machine). Thus, even if a player's auto-transfer amount is set at $200, the actual value transferred to the gaming machine on the casino floor would be limited to $100 in this example. In this way, the casino can balance player preferences with operational concerns such as security and risk management.

In some implementations, limits on auto-transfer parameters may be imposed for individual games, for groups of games, for specific smart cards (e.g., for individual players), for groups of players, for different casino properties, etc. Furthermore, the types of limits imposed may include threshold values (e.g., as discussed in the preceding paragraph), percentage-based restrictions (e.g., an auto-transfer value limited to 75% of the credit balance), or other types of limitations. In some implementations, more than one limit on a smart card parameter may be imposed

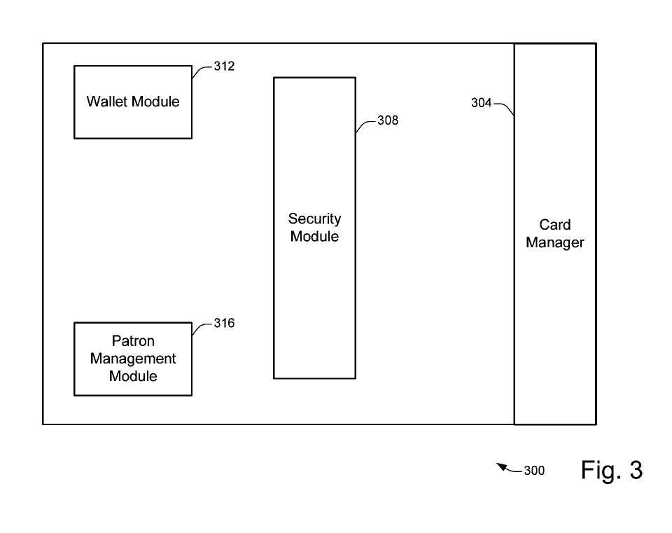

FIG. 3 shows a block diagram 300 illustrating a registered player smart card, constructed in accordance with one implementation. Smart card 300 is a registered smart card that includes personal identification information and/or other information (e.g., name, identification number, etc.) associated with one or more specific users.

In some implementations, the registered smart card 300 may be operable to communicate with one or more other devices in a gaming network by being placed in a smart card slot, such as the smart card slot 132. However, in different implementations, the registered smart card 300 may communicate using one or more different techniques, for example communication via a SIM card slot (e.g., SIM card slot 136) and/or wireless communication.

The registered smart card 300 may include one or more hardware and/or software modules for performing functions related to cashless gaming. Each module may include data and/or program instructions. In some implementations, one or more modules may be preloaded on the registered smart card 300 when the smart card is constructed. In addition, or alternately, one or more modules may be configured and/or loaded on the registered smart card 300 via a device in a casino environment such as a gaming machine.

In many respects, the registered smart card 300 may be substantially similar to the unregistered smart card 200 shown in FIG. 2. For example, the registered smart card 300 includes a card manager 304, a security module 308, and a wallet module 312 that may be substantially similar to the corresponding modules illustrated in FIG. 2.

In some implementations, the wallet module 312 may be configured to store and access multiple purses or credit balances. Furthermore, the various credit balances may be denominated in cash, casino credits, points, or any other units. Different credit balances that may be stored on the smart card may include, but are not limited to, one or more of the following: a gambling balance, a non-gambling balance, promotional dollars, bonus points, loyalty points, player tracking points, etc.

In some implementations, access to different purses may be limited to specific STMs, or STMs in particular types of machines. That is, only certain STMs may possess the security permissions necessary to access purses. For example, access to gambling-related purses may be limited to gaming machines, cashier terminals, etc. Access to promotional purses may be limited to patron management terminals or systems where awards may be redeemed. Access to non-gambling cash may be limited to point-of-sale interfaces (e.g., in shops or restaurants) and cashier's terminals.

Enforcing these types of access controls may provide casinos with the ability to facilitate flexible smart card use while retaining control over access to disparate purses by different systems and entities. Further, enforcing separation of funds may assist in ensuring that implementations of the cashless gaming system comply with regulatory requirements related to separation of gambling and non-gambling funds.

In some implementations, access to different purses may be controlled by different PINs. For example, access to one or more gambling-related purses may require a first PIN, while access to one or more non-gambling purses may require a second PIN. Separate access controls may allow, for instance, a player to lend a smart card to a different person (e.g., a minor) for limited uses (e.g., non-gambling uses, restaurant purchases, shop purchases, hotel purchases, redemption of awards, etc.).

In addition to the components included in the unregistered smart card 200, registered smart card 300 includes a patron management module 316. The patron management module 316 is a hardware and/or software module that includes data and/or program instructions for performing one or more user-specific operations. For example, the patron management module 316 may store information related to one or more names, ranks, player identification numbers, PINs, preferred languages, and/or other information specific to one or more users. As another example, the patron management module 316 may include program instructions associated with verifying a user's identity and/or performing one or more player tracking operations.

The patron management module may also be used to store and/or adjust one or more non-cash values related to loyalty awards, extra credits, offline bonuses, etc. In some implementations, if a player is credited with a free meal or free game plays, those values may be stored on the smart card by the patron management module. Then, the player may redeem the credit or award by presenting the smart card at the appropriate time.

According to various implementations, various techniques may be used to add and/or modify one or more parameter values stored on the registered smart card 300. In some implementations, these techniques may be similar to those discussed with respect to unregistered smart card 200. However, in some implementations, registered smart card 300 may be treated differently than unregistered smart card 200. For example, a casino may not require authentication steps in order to change values stored on the unregistered smart card 200 since the unregistered smart card 200 is not tied to a specific user. In contrast, since registered smart card 300 is tied to a specific user, a casino may require that the user provide identification information (e.g., an ID card, biometric identification information, etc.) and/or perform one or more electronic authentication operations in order to modify one or more values stored on the smart card. As another example, a user associated with registered smart card 300 who wishes to change one or more values stored on a registered card may need to provide identification information to casino personnel (e.g., at a kiosk, patron management terminal, etc.).

FIG. 4 shows a block diagram 400 illustrating a smart card for use in a cashless gaming device, constructed in accordance with one implementation. The smart card shown in FIG. 4 is configured or designed for use as an Secure Transaction Module (STM) card. The STM card 400 may be configured and/or designed for use in performing and/or facilitating one or more security validation and/or communication operations associated with secure transactions at a gaming apparatus.

In some implementations, the STM card 400 may be operable to communicate with one or more other devices in a gaming network by being placed in a SIM card slot, such as the SIM card slot 136. However, in different implementations, the STM card 400 may communicate using one or more different techniques, for example communication via a smart card slot (e.g., the smart card slot 132) and/or wireless communication.

The STM card 400 may include one or more hardware and/or software modules for performing functions related to cashless gaming. Each module may include data and/or program instructions. In some implementations, one or more modules may be preloaded on the STM card 400 when the smart card is constructed. In addition, or alternately, one or more modules may be configured and/or loaded on the STM card 400 via a device in a casino environment such as a gaming machine.

In many respects, the STM card 400 may be substantially similar to the unregistered smart card 200 shown in FIG. 2 and the registered smart card 300 shown in FIG. 3. For example, the STM card 400 includes a card manager 404 and a security module 408 that may be substantially similar to the corresponding modules illustrated in FIGS. 2 and 3. However, since the STM card 400 is not issued to a player, it may not need to include, for example, a wallet module and/or patron management module.

Another difference between the STM card 400 and the smart cards 200 and 300 shown in FIGS. 2 and 3 is that the STM card 400 includes a Secure Transaction Manager (STM) module 412. The STM module 412 is a hardware and/or software module that includes data and/or program instructions for performing one or more operations related to securely facilitating cashless gaming transactions (e.g., with a smart card). In some implementations, the STM module 412 may be operable to communicate with a smart card (e.g., via the card reader 112). Additionally, or alternately, the STM module 412 may be operable to communicate with one or more servers in a cashless gaming system (e.g., the host systems 124).

In some implementations, the STM module 412 includes one or more cryptographic keys for communication using a secured cryptosystem (e.g., a public key cryptosystem). In this way, communication between the STM module 412 and a smart card (e.g., a smart card in communication with smart card slot 132) may be encrypted. In addition, or alternately, communication between the STM module 412 and one or more system components (e.g., SMIB 104) and/or remote servers (e.g., host systems 124) may be encrypted. In some implementations, the STM module 412 may be registered with one or more remote servers.

Such registration may take place, for example, each time a gaming machine or cashless gaming terminal is powered up. Alternately, or additionally, registration may occur during use of the gaming machine or cashless gaming terminal (e.g., at scheduled times, intermittently, etc.). In some implementations, the registration process may be integrated with one or more procedures for registering gaming machines, such as the Advantage Bonus System and/or Easy Pay systems available from IGT.

At certain instances, use of a smart card at a gaming apparatus may involve authenticating the smart card to a remote server, such as a cashless gaming server. Such authentication may involve, for example, verifying the authenticity of the smart card (e.g., using one or more cryptographic keys), verifying one or more previous transactions associated with the smart card, verifying the identity of the smart card user, etc.

In some implementations, an authentication attempt may be made during, before, and/or after each cashless gaming session and/or other use of the smart card. Alternately, an authentication attempt may be made only upon occasion (e.g., periodically, when triggered, etc.).

However, in some instances, such authentication may be impossible and/or impracticable. For example, one or more network elements and/or servers may be temporarily and/or periodically inoperable. As another example, the gaming apparatus at which the card is being used may not enjoy continuous communication with a cashless gaming server.

Thus, in some implementations, the STM module 412 may include one or more parameter values associated with one or more offline windows. An offline window value may represent, for example, a length of time between the last authenticated use of a specific smart card and the time in which it must be authenticated again before it can be used further. In some implementations, the offline window is 24 hours, which means that if a given smart card has been authenticated with a remote cashless gaming server at a particular time (e.g., during use for a cashless gaming session), that smart card may be used for 24 hours without requiring that the smart card be authenticated again with a remote cashless gaming server. According to various implementations, the offline window may be any value between 0 hours (e.g., offline use is not permitted) to several weeks.

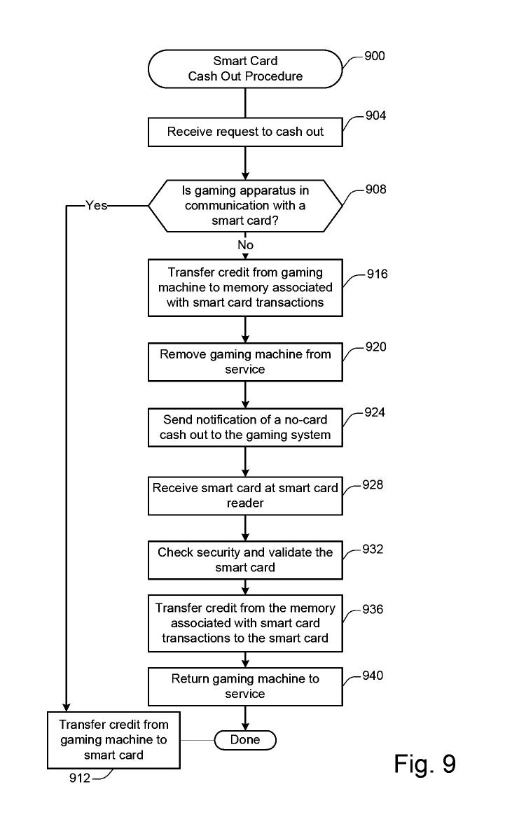

The use of an offline window may allow the player to use the smart card even if remote authentication of the card is not performed. However, if it is determined that the previous authenticated use of the smart card falls outside of the offline use window, then the gaming apparatus may refuse to add and/or retransfer credit from the smart card. Further details of the use of offline windows are discussed in relation to FIGS. 9, 11, and 13.

In some implementations, one or more parameter values stored on the STM card 400 may be stored upon initialization of the STM card. For example, the STM card 400 may store one or more parameters related to offline windows, cryptographic keys, card value limits for unregistered smart cards, etc. Storing one or more parameter values on the STM card may allow the casino to exercise control over the cashless gaming system, such as providing useful ways to manage risk. For example, a casino may dynamically alter the maximum credit balance that may be stored on unregistered smart cards. If the casino knows that there are many players using unregistered smart cards, for instance, the casino may reduce the maximum credit balance that may be stored on unregistered smart cards in order to reduce risk (e.g., in the event of system failure).

In some implementations, such parameters may not be modified after they have been stored on the card. For example, the STM card 400 may include write-once memory so as to thwart attempts to tamper with the STM card 400. However, in different implementations, it may be possible to modify one or more parameter values stored on the STM card 400 and/or add new parameter values. For example, a casino employee may be able to update one or more parameter values stored on the STM card 400 by accessing the STM card 400 via a gaming apparatus (e.g., by providing appropriate credentials, cryptographic keys, security verification information, etc.).

FIGS. 5-13 show methods related to cashless gaming transactions that may be performed in conjunction with a smart card. According to various implementations, one or more of the methods may be performed via one or more gaming apparatuses in communication with a smart card and/or STM. For example, one or more methods may be performed via gaming apparatus 104 in communication with a smart card via smart card slot 132 and an STM card via SIM card slot 136. According to various implementations, one or more of the methods may be performed at various locations. For example, one or more operations associated with the methods may be performed at cashier terminal, at a patron management terminal, at a kiosk, at a gaming machine, etc.

In some implementations, one or more of the methods illustrated in FIGS. 5-13 may be preceded by one or more authentication operations. For example, one or more components associated with a gaming apparatus may communicate with the smart card and/or STM card to establish a secure communications session. In some implementations, the smart card and STM card may exchange public keys used in a public key cryptosystem and/or exchange session keys.

Although the operations illustrated in FIGS. 5-13 are illustrated as occurring in a particular order, in some implementations one or more methods may include operations which may be performed in a different order. In addition, some implementations may include additional operations not illustrated in FIGS. 5-13, and/or some operations may be omitted.

FIG. 5 shows a method 500 for retrieving a parameter value from a smart card, performed in accordance with one implementation. The Retrieve Smart Card Parameter Value Procedure 500 may be used to retrieve one or more parameter values stored on a smart card when the smart card is in communication with a cashless gaming apparatus. For example, a smart card user, casino personnel, and/or a program running on a gaming apparatus may make a request to update a parameter value stored on the smart card.

The Retrieve Smart Card Parameter Value Procedure 500 may be performed at various instances and/or upon various triggering events. For example, a smart card user, casino personnel, and/or a program running on a gaming apparatus may make a request to retrieve a parameter value stored on the smart card. As another example, one or more operations illustrated in FIG. 5 may be performed upon card initialization, upon inserting a smart card into a gaming apparatus, etc.

At 504, instructions are transmitted from the cashless gaming apparatus to the smart card to call a function on the smart card to retrieve one or more parameter values. The requested parameter values may include, for example, one or more credit balances, auto-transfer threshold values, auto-transfer amounts, player names, player ranks, player ID's, smart card serial numbers, PINs, etc. In some implementations, the request may be cryptographically signed by the STM card before being transmitted to the smart card.

At 508, a determination is made as to whether the request to retrieve one or more parameter values satisfies one or more permissions and/or rules. In some implementations, the determination is made at an application or software module running on the smart card (e.g., the security module 208). The determination may be made, at least in part, based upon whether the request has been signed and/or encrypted by a valid and/or approved STM card. The determination may involve a handshaking and/or key exchange process. For example, a key signature may be stored in the transaction record on the card and on the STM. If these key signatures match, then the request may be considered valid.

In some implementations, all valid STM cards may have permission to retrieve any value from a smart card. However, in different implementations, permission to retrieve one or more values from a smart card may be limited to certain types of gaming apparatuses equipped with appropriately configured STM cards. Thus, operation 508 may involve determining whether the STM card that transmitted the request to retrieve one or more parameter values has permission to retrieve those values. For example, an STM card associated with a patron management terminal may not have permission to access values stored in the wallet module, such as an auto-transfer amount. However, an STM card associated with a cashier's terminal may have permission to access one or more values stored in the wallet module, such as a credit balance.

At 512, when it is determined that the request to retrieve one or more parameter values satisfies the permissions and/or rules, the one or more parameter values are transmitted from the smart card to the gaming machine. In some implementations, the parameter values are transmitted as part of a secure communications session between the smart card and an STM card. Thus, the STM card may decrypt the communication from the smart card that includes the parameter values before transmitting the communication and/or the parameter values to a different device in the gaming apparatus, such as the SMIB 104. Alternately, or additionally, one or more parameter values may be transmitted in an unencrypted state.

It should be noted that in some implementations, certain requests to retrieve one or more parameter values may not require the use of operation 508. For example, a smart card may freely transmit information such as a user's name and/or identification number. In different implementations, however, each request to retrieve one or more parameter values must be validated by the smart card.

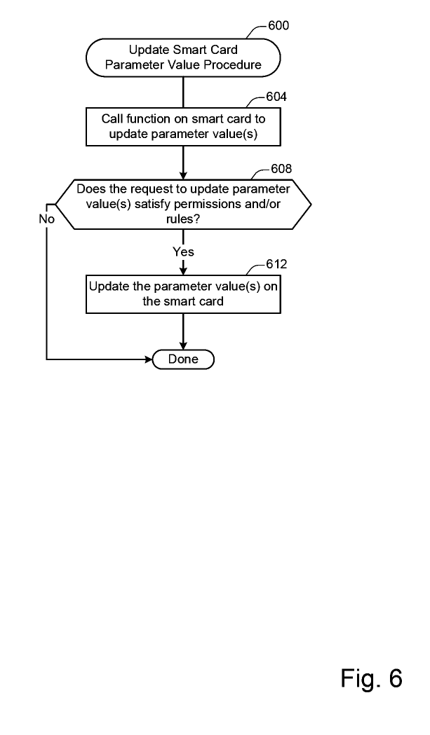

FIG. 6 shows a method 600 for updating a smart card parameter value, performed in accordance with one implementation. The Update Smart Card Parameter Value Procedure 600 may be used to update one or more parameter values stored on a smart card when the smart card is in communication with the cashless gaming apparatus. For example, a smart card user, casino personnel, and/or a program running on a gaming apparatus may make a request to update a parameter value stored on the smart card.

At 604, instructions are transmitted from the cashless gaming apparatus to the smart card to call a function on the smart card to update one or more parameter values. The parameter values included in the update request may include, for example, one or more credit balances, auto-transfer threshold values, auto-transfer amounts, player names, player ranks, player ID's, smart card serial numbers, PINs, etc.

At 608, a determination is made at an application running on the smart card as to whether the request to update one or more parameter values satisfies one or more permissions and/or rules. In some implementations, the determination is made by a security module on the smart card (e.g., the security module 208). The determination may be made, at least in part, based upon whether the request has been signed and/or encrypted by a valid and/or approved STM card.

According to various implementations, permission to perform one or more operations on a smart card, such as updating a parameter value, may be limited to certain types of gaming apparatuses and/or certain STM cards. Thus, operation 608 may involve determining whether the STM card that transmitted the request to update one or more parameter values has permission to update those values.

For example, an STM card associated with a patron management terminal may not have permission to update one or more parameter values stored in the wallet module, such as an auto-transfer amount. However, an STM card associated with a cashier's terminal may have permission to update one or more parameter values stored in the wallet module.

As another example, an STM card associated with a gaming machine may be permitted to update one or more values associated with the wallet module (e.g., auto-transfer amount and/or auto-transfer threshold values) of an unregistered smart card (e.g., smart card 200), since the unregistered smart card is not tied to the identity of a specific user. However, the same STM card may not have permission to update one or more values associated with the wallet module of a registered smart card, since a casino may wish to validate the identity of a player in person before allowing such a change.

One reason for enforcing such permissions may be security. For example, permission to transfer funds for purposes of cashing out a smart card may be limited to secure devices that are under the control of casino personnel. Thus, removing funds from a smart card for the purpose of awarding cash to the player may be limited to situations in which designated casino personnel or computing system can verify the smart card balance, past smart card balance transfers, the player identity, and other such information.

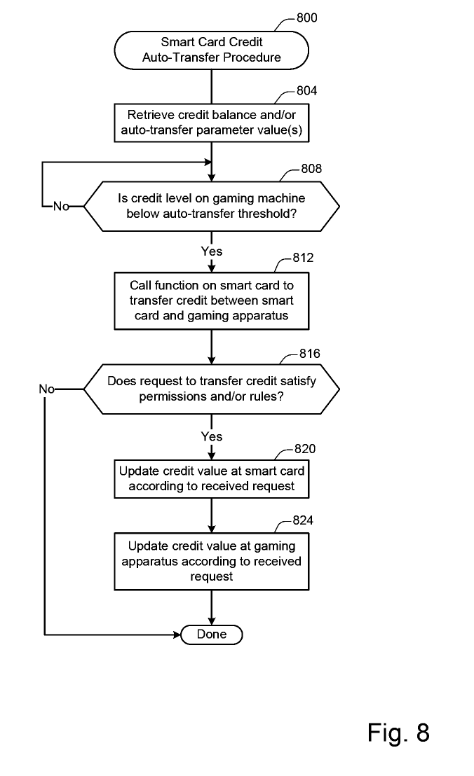

Another reason for enforcing such permissions may be to ensure that inappropriate parameter values are not stored to the smart card. For example, as is discussed with respect to FIG. 8, one or more devices in the cashless gaming system may be configured or designed to automatically transfer credit from a smart card when a credit balance on a gaming machine drops below an auto-transfer threshold value. However, if the difference between the auto-transfer threshold value and the auto-transfer amount is too small, the transfers from the smart card to the gaming machine may be too frequent, resulting in excessive wear on the smart card and/or excessive authorization attempts with one or more remote servers. Thus, limiting permission to update values such as the auto-transfer threshold value and/or auto-transfer threshold amount to certain STMs (e.g., STMs installed at gaming apparatuses operated by casino personnel) may ensure that only appropriate parameter values are stored to the smart card. Additionally, or alternately, one or more gaming apparatuses may be configured or designed to automatically enforce restrictions on parameter values.

At 612, when it is determined that the request to update one or more parameter values satisfies the permissions and/or rules, the one or more parameter values are updated on the smart card. In some implementations, the smart card may transmit an indication and/or confirmation that the one or more parameter values were successfully updated. In some implementations, the parameter values are transmitted as part of a secure communications session between the smart card and an STM card. Thus, the STM card may decrypt the communication from the smart card that includes the update confirmation before transmitting the communication and/or an indication that the values were successfully updated to a different device in the gaming apparatus, such as the SMIB 104. In different implementations, the smart card may not transmit an indication and/or confirmation of a successful update. In such implementations, the Retrieve Smart Card Parameter Value Procedure 500 shown in FIG. 5 may be used to determine whether one or more parameter values was successfully updated.

It should be noted that in some implementations, certain requests to update one or more parameter values may not require the use of operation 608. For example, a smart card may permit a user, casino employee, and/or program running at a gaming apparatus to update low-security information (e.g., a preferred language) without requiring one or more authentication and/or request validation operations.

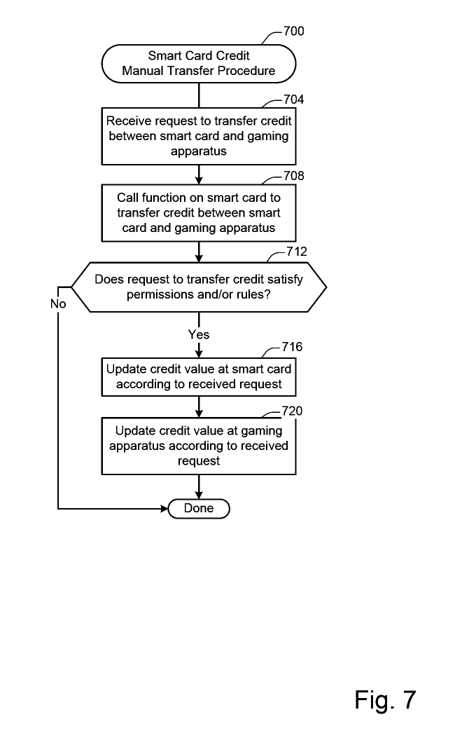

FIG. 7 shows a method 700 for manually transferring credit to or from a smart card, performed in accordance with one implementation. The Smart Card Credit Manual Transfer Procedure 700 may be used to transfer credit from a gaming apparatus to a smart card or from a smart card to a gaming apparatus. For example, a smart card manual transfer procedure may be used at a cashier terminal in order to add credit to a smart card. The Smart Card Credit Manual Transfer Procedure 700 may also be used at a cashier terminal to convert credit stored on the smart card to cash for providing to a player associated with the smart card. As another example, the Smart Card Credit Manual Transfer Procedure 700 may be used at a gaming machine in order to transfer credit from the gaming machine to the smart card or from the smart card to the gaming machine.

At 704, a request is received to transfer credit between the smart card and a gaming system. According to various implementations, the request may be received at one or more apparatuses in a cashless gaming system (e.g., a cashier terminal, a gaming machine, etc.).

In some instances, the request to transfer credit may represent a request to transfer credit stored on the smart card to a gaming apparatus. Such a transfer may be requested, for example, to facilitate cashless gaming on a gaming machine or to award cash to a player based on the credit stored on the smart card (i.e. “cash out” the smart card). In other instances, the request to transfer credit may represent a request to transfer credit stored on the gaming apparatus to the smart card. Such a transfer may be requested, for example, to add additional funds to the smart card and/or at the end of a cashless gaming session at a gaming machine.

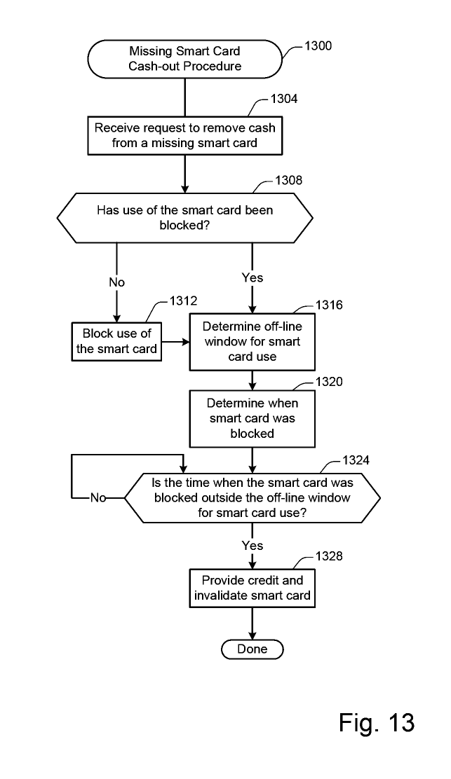

In some implementations, some requests to transfer credit may be performed by casino personnel and/or may require supervision by casino personnel. For example, permission to request to transfer credit from a smart card to a cashier terminal for the purpose of cashing out a smart card may be limited to designated casino employees, such as cashiers. In addition, or alternately, one or more additional operations may be required when cashing out a smart card. Further details related to cashing out a smart card are discussed in relation to FIGS. 9 and 13.

In some implementations, some or all requests to transfer credit may require a user to provide identification and/or security verification information, such as a PIN. For example, a player may be required to provide a PIN number, produce an ID card or provide other forms of identification information. As another example, a casino employee making a request to transfer credit and/or assisting a user in making such a request may be required to provide a PIN and/or other verification information.

At 708, instructions are transmitted to call a function on the smart card to transfer credit between the smart card and the gaming apparatus. In some implementations, the instructions are transmitted from a component associated with the gaming apparatus, such as the SMIB 104, via an STM card associated with the gaming apparatus (e.g., an STM card in communication with SIM card slot 136).

At 712, a determination is made by an application running on the smart card as to whether the request to transfer credit satisfies one or more permissions and/or rules. In some implementations, the determination is made by a security module on the smart card (e.g., the security module 208). The determination may be made, at least in part, based upon whether the request has been signed and/or encrypted by a valid and/or approved STM card.

According to various implementations, permission to transfer credit to or from the smart card may be limited to certain types of gaming apparatuses and/or certain STM cards. Thus, operation 712 may involve determining whether the STM that transmitted the request to update one or more parameter values has permission to update those values. In some implementations, permission to transfer credit to or from a smart card may be limited to a gaming machines and cashier's terminals. However, in different implementations, different security permissions and/or rules may be used.

The determination made at operation 712 may be made at least in part based on whether the request complies with one or more authentication parameters specific to transferring credit. In some implementations, transferring credit between a gaming apparatus and the smart card may require that the user verify knowledge of a PIN that is stored on the smart card. In this case, a PIN may be collected from the user of the gaming apparatus and transmitted along with the request to transfer credit at operation 708. Then, the PIN received with the request may be checked against a PIN stored on the smart card, such as a PIN stored in the security module 208 illustrated in FIG. 2. If the PINs do not match, the request to transfer credit may be denied.

At 716, when it is determined that the request to transfer credit satisfies one or more permissions and/or rules, the credit value stored on the smart card is updated according to the received transfer request. For example, if the received request represented a request to transfer credit from the smart card to the gaming apparatus, the credit value stored on the smart card may be decreased by the amount of credit included in the request. As another example, if the received request represented a request to transfer credit from the gaming apparatus to the smart card, the credit value at the smart card may be increased according to the value included with the received transfer request.

At 720, the credit value at the gaming apparatus is updated according to the received request. For example, if the request represented a request to transfer credit from the smart card to the gaming apparatus, the credit value stored on the gaming apparatus may be increased according to the value included in the received request. As a different example, if the request represented a request to moved credit from the gaming apparatus to the smart card the credit value stored on the gaming apparatus may be decreased according to the amount included in the received request.

In some implementations, the credit balance on the gaming apparatus may be stored and updated in non-volatile memory associated with making secure transactions with smart cards. For example, the credit balance may be stored in memory 144 associated with the SMIB 108 shown in FIG. 1. In this way, a credit balance may be safely maintained during a secure transaction with a smart card, even in the event of a system failure or power outage.

FIG. 8 shows a method 800 for automatically transferring credit to or from a smart card, performed in accordance with one implementation. In some implementations, one or more operations associated with the Smart Card Credit Auto Transfer Procedure 800 may be performed using one or more devices in a cashless gaming system. For example, the Smart Card Credit Auto Transfer Procedure 800 may be performed at a gaming machine (e.g., gaming apparatus 104) in communication with a smart card (e.g., via smart card slot 132).

In some implementations, The Smart Card Credit Auto Transfer Procedure 800 may be used to automatically transfer credit from a smart card to a gaming machine. For example, when the credit balance on a gaming machine drops below a predetermined threshold value, the Smart Card Credit Auto Transfer Procedure 800 may operate to automatically transfer credit from the smart card to the gaming machine. In this way, the user of a gaming machine may continue to play a gaming machine with additional credit transferred as needed from the smart card without having to specifically request that funds be transferred from the smart card. In addition, the player need not transfer all of the credit stored on the smart card to the gaming machine at a given time, but rather can maintain a credit balance on the gaming machine appropriate to the player's wishes.

At 804, a credit balance and one or more auto-transfer parameter values are retrieved from the smart card. In some implementations, one or more of these values may be stored in a module on the smart card, such as wallet module 212. A procedure for retrieving one or more such values is described, for example, in relation to the Retrieve Smart Card Parameter Value Procedure 500 illustrated in FIG. 5.

In some implementations, the credit balance retrieved may be measured in U.S. currency. However, in some implementations, the credit balance retrieved may be measured in a different unit, such as casino credits or game credits. For example, the smart card may be designed or configured to store game-specific credits limited to use with one or more specific games.

The one or more auto-transfer parameter values may include, for example, one or more of an auto-transfer threshold value, an auto-transfer amount, and any other parameter values related to an auto-transfer. The auto-transfer threshold value may represent, for example, a threshold value for triggering an auto-transfer of funds from the smart card to the gaming machine. The auto-transfer amount value may represent an amount of credit to transfer to the gaming machine when an auto-transfer of credit is triggered.

In some implementations, one or more of the auto-transfer parameters values may be user-configurable. In this way, a user may configure a smart card to always transfer a certain credit amount to the gaming machine. It is anticipated that such configuration options may be beneficial in encouraging smart card adoption, since many players prefer to add a specific “lucky” amount of credit or cash to a gaming machine each time.

In some implementations, one or more of the auto-transfer parameters values may be system-configurable. For example, different STMs may impose different limits on credit transfer. A low-denomination gaming machine, for instance, may limit the auto-transfer amount to avoid an unreasonable credit transfer (e.g., transferring $1,000 to a penny slot machine).

At 808, a determination is made as to whether the credit level on the gaming machine is below the auto transfer threshold value. According to different implementations, the determination may be made at different locations and/or by different software programs. In some implementations, the determination may be made by a program running on the CPU 140 of the SMIB 108 illustrated in FIG. 1. In a different implementation, the determination may be made at a different component of the gaming apparatus (e.g., the master gaming controller). In another implementation, the determination may be made at the smart card.

At 812, instructions are transmitted to call a function on the smart card to transfer credit between the smart card and the gaming apparatus. In some implementations, the instructions are transmitted to the smart card from a component associated with the gaming apparatus, such as the SMIB 104, via an STM card associated with the gaming apparatus (e.g., an STM card in communication with SIM card slot 136).

According to various implementations, various techniques may be used to determine the amount of credit to request for transfer. For example, the amount of credit requested for transfer may be determined based on one or more of the auto-transfer amount value, the auto-transfer threshold value, and the current credit balance on the gaming machine. In some implementations, the amount of credit requested for transfer may be sufficient to bring the current credit balance available on the gaming machine up to the sum of the auto-transfer threshold and auto-transfer amount. In some implementations, the amount of credit requested for transfer may be equivalent (or substantially equivalent) to the auto-transfer amount.

In some implementations, the amount of credit requested for transfer may be limited by the credit balance retrieved from the smart card. For example, the gaming apparatus may not request to transfer more credit than is available on the smart card. Alternately, the gaming apparatus may instead rely on the smart card to transfer the appropriate amount of credit if the amount of credit requested exceeds the credit balance stored on the smart card.

At 816, a determination is made at an application running on the smart card as to whether the request to transfer credit satisfies one or more permissions and/or rules. In some implementations, the determination made at 816 may be substantially similar to the determination made at operation 712 illustrated in FIG. 7.

At 820, when it is determined that the request to transfer credit satisfies one or more permissions and/or rules, the credit value stored on the smart card is updated according to the received transfer request. In some implementations, updating the credit value at the smart card as performed at operation 820 may be substantially similar to operation 716 illustrated in FIG. 7.

At 824, the credit value at the gaming apparatus is updated according to the received request. In some implementations, updating the credit value at the gaming apparatus as performed at operation 824 may be substantially similar to operation 720 illustrated in FIG. 7.

FIG. 9 shows a method 900 for cashing out to a smart card, performed in accordance with one implementation. The Smart Card Cash Out Procedure 900 may be used to move credit stored on a gaming apparatus (e.g., a gaming machine) to a smart card.

Traditionally, a gaming machine may have responded to a request to cash out by providing cash or a ticket directly to a player. However, providing an item of value to the player without supervision from casino personnel may lead to concerns regarding security and/or fraudulent transactions. As discussed herein, providing credit to a player via a smart card may, for example, ensure that one or more gaming transactions are reviewed and/or verified before the player is provided with cash. In addition, using a smart card for cashing out the gaming machine may allow a casino to limit the issuance of physical cash to certain secure locations within a casino (e.g., cashier's terminals). Finally, using a smart card for cashing out the gaming machine may allow paying a player without any use of physical cash. For example, when the player takes the smart card to a cashier, the player could be given a check instead of cash.

However, it is anticipated that some players may initiate play at a gaming machine without having a smart card. In order to permit such play while retaining one or more benefits associated with use of a smart card for cashing out a gaming machine, techniques are described for facilitating cashing out a gaming machine by using a smart card even when the gaming machine is not initially in communication with a smart card.

At 904, a request is received to cash out the gaming machine to the smart card. According to various implementations, the request may be received from a gaming machine user, a casino employee, or software and/or hardware associated with the gaming machine. In some instances, the request to cash out received at 904 may represent a request to remove all the cash stored on the gaming machine. However, in other instances, the request received to cash out at 904 may represent a request to transfer only some of the cash stored on the gaming machine to the smart card.

In some implementations, the request to cash out the smart card may be received via user input device 116 illustrated in FIG. 1. For example, the amount of credit stored on the smart card may be displayed via display 120 illustrated in FIG. 1. Then, a user may use the device 116 to request that some or all of the credit stored on the smart card be transferred to the gaming apparatus for purposes of cashing out the smart card.

At 908, a determination is made as to whether the gaming apparatus is in communication with the smart card. For example, one or more components associated with the cashless gaming system 100 illustrated in FIG. 1 may determine whether the gaming apparatus 104 is in communication with a smart card via smart card slot 132.

At 912, when it is determined that the gaming apparatus is in communication with the smart card, credit may be transferred from the gaming machine to the smart card. As discussed herein, various techniques may be used to transfer credits between a gaming machine and a smart card. For example, credit may be transferred from the gaming machine to the smart card using one or more operations described with respect to Smart Card Credit Manual Transfer Procedure 700 illustrated in FIG. 7.

At 916, when it is determined that no smart card is present, credit is transferred from the gaming machine to memory associated with smart card transactions. For example, credit may be transferred from the gaming machine to the memory 144 associated with the SMIB 108 illustrated in FIG. 1. In some implementations, the memory associated with smart card transactions may be nonvolatile memory so that if the procedure for cashing out the gaming machine is interrupted (e.g., by a power outage or gaming machine reset), the credit will not be lost.

At 920, the gaming machine is removed from service. Removing the gaming machine from service may involve, for example, placing the gaming machine in a state in which no further wagering or game play may be conducted until the gaming machine is returned to service. In some implementations, certain functionality associated with the gaming machine may remain in operation when the gaming machine is removed from service. For example, the gaming machine may permit continued operation of features related to ordering food and beverages, changing game options, and/or other features that do not directly involve further game play.

At 924, a notification of a no-card cash out is sent to the gaming system. In some implementations, the notification of a no-card cash out may be sent over the gaming network (e.g., via communication link 124 illustrated in FIG. 1). In addition, or alternately, the notification of a no-card cash out may be provided at the gaming machine. For example, one or more audible and/or visible alarms may be activated (e.g., a gaming machine candle may be lit). In some implementations, the notification of a no-card cash out may be used to attract the attention of casino personnel. For example, casino personnel may see that a player without a smart card would like to cash out a gaming machine and respond by bringing a new smart card to the player.

At 928, a smart card is received at the smart card reader. For example, the smart card may be received at smart card reader 132 illustrated in FIG. 1. In some implementations, the smart card may be brought by a casino employee to the gaming machine. In some implementations, the smart card may be supplied automatically by a device associated with the cashless gaming network. For example, the gaming machine may be coupled with a device configured to supply a new smart card to a player if the player does not already possess a smart card. Either the player or the casino employee may insert the smart card into the smart card reader.

In some implementations, the smart card may be an unregistered or “day use” smart card (e.g., Unregistered Smart Card 200 illustrated in FIG. 2). However, in some implementations the smart card may be registered to the player (e.g., Registered Smart Card 300 illustrated in FIG. 3). For example, a casino employee who provides a smart card to the player may use a portable handheld device to register the smart card for the player. As another example, a device at the gaming machine capable of providing a new smart card to the user may also be capable of performing one or more smart card registration operations (e.g., with supervision by a casino employee, by providing a source of identification information such as a credit card, etc.).

At 932, security is checked and the smart card is validated. In some implementations, the operations performed for checking security and validating the smart card may be substantially similar to authentication operations performed whenever a smart card is inserted into the smart card reader. For example, one or more operations may be performed that are related to establishing a secure communication session, authenticating the smart card with one or more remote servers, determining whether to permit offline use of the smart card, etc.

At 936, credit is transferred from the memory associated with smart card transactions to the smart card. For example, the credit may be transferred from memory 144 to a smart card in communication with smart card slot 132. In some implementations, one or more operations performed in conjunction with transferring credit to the smart card may be substantially similar to operations discussed in relation to Smart Card Credit Manual Transfer Procedure 700 illustrated in FIG. 7.

At 940, the gaming machine is returned to service. In some implementations, the gaming machine may be returned to service automatically once one or more operations associated with cashing out the gaming machine are completed. However, in some implementations, the gaming machine may remain out of service until a casino employee (e.g., an employee who provided the smart card) provides input to the gaming machine. For example, the casino employee may supply a digital and/or physical key to return the gaming machine to service.

In some implementations, one or more of the operations illustrated in FIG. 9 may be omitted. For example, credit may be left on the gaming machine until a smart card is available, and then transferred directly to the smart card. As another example, separate operations for checking security and validating the smart card may be unnecessary if the new smart card is provided by the gaming machine.

In some implementations, one or more operations illustrated in FIG. 9 may be performed in a different order and/or concurrently. For example, the gaming machine may be removed from service before transferring credit from the gaming machine to memory associated with smart card transactions. As another example, a notification of a no-card cash out may be transmitted immediately upon making a determination at 908 that the gaming machine is not in communication with the smart card.

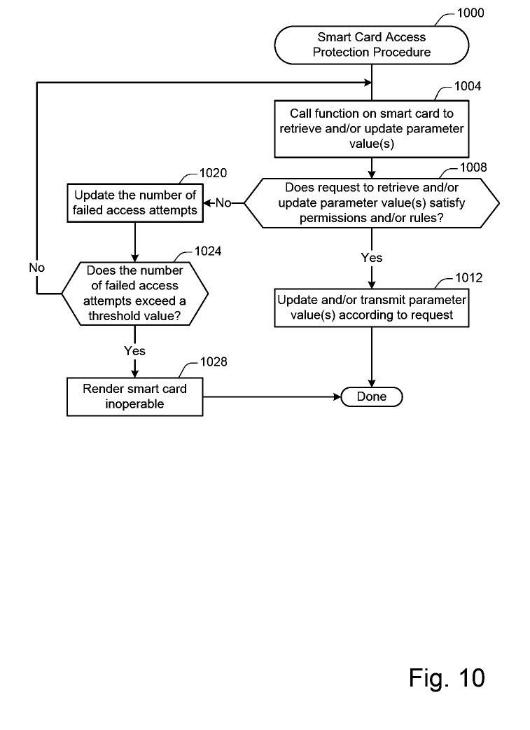

FIG. 10 shows a method 1000 for protecting smart card access, performed in accordance with one implementation. The Smart Card Access Protection Procedure 1000 may be performed by one or more devices in a cashless gaming system in communication with a smart card. For example, the Smart Card Access Protection Procedure 1000 may be performed at gaming apparatus 104 in communication with a smart card via smart card slot 132.

The Smart Card Access Protection procedure 1000 may be used to render the smart card at least partially inoperable in response to repeated failed access attempts. For example, if retrieving and/or updating one or more values stored on the smart card requires that the user supply the correct PIN, and the user repeatedly supplies incorrect PINs, then the smart card may be rendered at least partially inoperable. As another example, if one or more values stored on the smart card may only be retrieved and/or updated from one or more specific types of gaming apparatuses, and repeated access attempts are made from one or more gaming apparatuses that do not have permission to retrieve and/or update the one or more values, the smart card may be rendered at least partially inoperable.

By rendering the smart card at least partially inoperable, an attacker may be prevented from altering one or more parameter values on the smart card in order to compromise the security of the smart card. In addition, an attacker may be prevented from moving funds off of the smart card.

In some implementations, one or more parameter values stored on the smart card may be read, but not updated, after the smart card is rendered inoperable. This may allow a user to take the smart card to a terminal and/or casino employee for further assistance. For example, the user may provide identification information to casino personnel and/or a cashless gaming apparatus to verify the user's identity if the user has lost or forgotten the PIN or other security information stored on the smart card. Then, one or more cash out procedures may be performed. Alternately, or additionally, the user may be issued a new smart card to replace the inoperable smart card.

At 1004, instructions are transmitted from the cashless gaming apparatus to the smart card to call a function on the smart card to retrieve and/or update one or more parameter values. At 1008, a determination is made as to whether the request to retrieve and/or update one or more parameter values satisfies one or more permissions and/or rules. At 1012, when it is determined that the request to retrieve and/or update one or more parameter values satisfies the permissions and/or rules, the one or more parameter values are transmitted from the smart card to the gaming machine and/or updated on the smart card. In some implementations, operations 1004, 1008, and/or 1012 may be substantially similar to operations 504, 508, and/or 512 illustrated in FIG. 5 and/or operations 604, 608, and/or 612 illustrated in FIG. 6.

At 1020, when it is determined that the request to retrieve and/or update one or more parameter values does not satisfy the permissions and/or rules, the number of failed access attempts is updated. In some implementations, the number of failed access attempts may be stored on the smart card. For example, the number of failed access attempts may be a parameter value stored in the security module 208 illustrated in FIG. 2 on the smart card.

Additionally, or alternately, the number of failed access attempts may be stored at one or more remote servers, such as host systems 124 illustrated in FIG. 1. For example, the smart card may transmit information associated with failed access attempts to host systems 124 when the smart card authenticates with the host systems.

Additionally, or alternately, the number of failed access attempts may be transmitted from the smart card to the gaming apparatus. Transmitting the number of failed access attempts to the gaming apparatus may allow, for example, a user to be informed of the risk that the smart card will be rendered inoperable. This may allow the user to request assistance from casino personnel (e.g., at a patron management terminal and/or cashier's terminal) instead of taking further action that may risk invalidating the smart card. For example, a user may have forgotten the PIN stored on the card and may be attempting to guess the PIN value.

In some implementations, updating the number of failed access attempts may include updating information based on a time period or time stamp associated with previous failed access attempts. For example, each failed access attempt may be associated with a time stamp. In some instances, failed access attempts that occurred in the past (e.g., more than 2 hours ago), may be removed.

In some implementations, the smart card, remote servers, and/or gaming apparatus may maintain more than one parameter values associated with the number of failed access attempts. For example, one parameter value may be associated with failed access attempts to high security features, such as removing funds from the smart card, while another parameter value may be associated with failed access attempts to low security features, such as changing a preferred language. Thus, in some implementations it may be possible to track failed access attempts without unnecessarily rendering the smart card inoperable.

At 1024, a determination is made as to whether the number of failed access attempts exceeds a threshold value. In some implementations, the determination is made on the smart card. For example, the security module 108 illustrated in FIG. 1 may make the determination.

The threshold value may represent a maximum number of failed access attempts before the smart card is rendered inoperable. In some implementations, the threshold value may be stored on the smart card, for example in the security module 108. Alternately, or additionally, a threshold value may be stored on the STM.

According to various implementations, different threshold values may be used. In some implementations, the threshold value is five failed access attempts since the most recent successful smart card use. However, in different implementations, the threshold value may be anywhere between 1 and 100.

In some implementations, the threshold value may be updated upon request by one or more devices in the cashless gaming system. For example, the threshold value may be updated upon authentication of the smart card with host systems 124 illustrated in FIG. 1. This may allow a casino to tailor the security provided by the smart card to the specific needs of the casino and/or particular users or groups of users. For example, a smart card that holds a relatively high credit balance may be assigned a relatively low failed access attempt threshold value, while a smart card that holds a relatively low credit balance may be assigned a relatively high failed access attempt threshold value. As another example, a user may request to raise or lower the failed access attempt threshold value.

In some implementations, the smart card may store different threshold values for different types of failed access attempts. For example, the smart card may store a first failed access attempt threshold value for high security access attempts, such as attempts to remove credits from the smart card, and a second failed access attempt threshold value for low security access attempts, such as attempts to change a preferred language.

In some implementations, one or more failed access attempt threshold values may include information related to a time period or timeout. For example, a smart card may be rendered inoperable only when the number of failed access attempts exceeds a certain threshold value (e.g., three attempts) in a certain period of time (e.g., 2 hours). In this way, a smart card will not be rendered inoperable based on failed access attempts spaced far apart in time.

At 1028, when it is determined that the number of failed access attempts exceeds a threshold value, the smart card is rendered at least partially inoperable. In some implementations, rendering the smart card inoperable may include performing at least one operation to physically prevent further updating of all or some parameter values stored on the card. For example, one or more circuits and/or communication interfaces may be fused or broken. As another example, a card may be broken, punched, bent, melted, or otherwise damaged or destroyed to render it inoperable.

In some implementations, rendering the smart card inoperable may include performing at least one software operation to prevent further updating of the smart card. For example, one or more modules or applets running on the smart card may store a value in memory that indicates that no further updating of parameter values may be performed.

In some implementations, information may be retrievable from the smart card by casino employees or systems once the smart card is rendered inoperable. For example, the player may be able to take the smart card to a service desk and provide confirmation of identity. The credit balance then may be retrieved and compared against a verified credit balance stored in the casino systems.

If the two values match, the player may be permitted to cash out the balance or transfer the balance to a new smart card. Acquiring a new smart card may require paying a fee (e.g., $5 or $10) and interacting with casino employees or systems. Thus, if a player repeatedly requires a new smart card, the player may incur costs and/or come to the attention of casino employees or systems. In this way, casinos may monitor and prevent attempts to tamper with or gain unauthorized access to smart cards in the cashless gaming system.

If instead the credit value stored on the smart card does not match the value stored in the casino systems, then the casino may investigate the cause of the discrepancy (e.g., systems failures, unauthorized smart card access, etc.). The casino can then make an operational decision about whether to allow the player to cash out the smart card and what the value of the cash out should be. In this way, the casino may be able to access at least some credit balance information even in the event of total system failure.

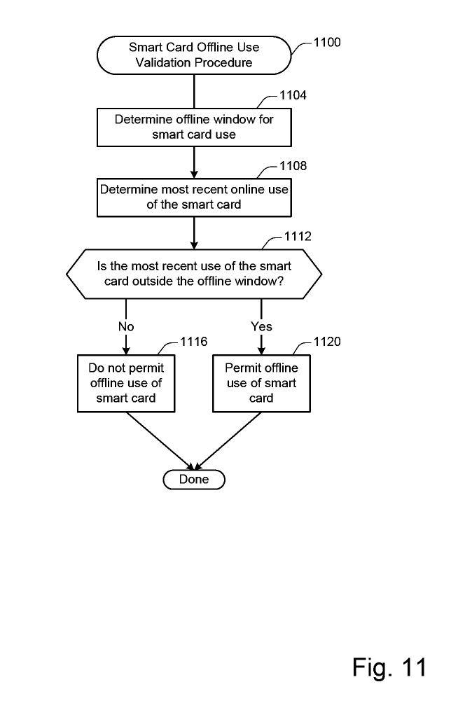

FIG. 11 shows a method 1100 for facilitating offline use of a smart card, performed in accordance with one implementation.

It is anticipated that in some instances, a player may attempt to use a smart card at a gaming apparatus (e.g., a gaming machine) that is not in communication with a cashless gaming server. For example, communications between the gaming machine and one or more cashless gaming servers may be temporarily disrupted. In some instances, communications may be temporarily disrupted due to network failure, network congestion, routine maintenance, etc. As another example, it may be desirable to permit use of the smart card without requiring communication between the gaming machine and one or more cashless gaming servers. In some instances, permitting use of the smart card without requiring authentication with one or more cashless gaming servers may help avoid network congestion, reduce usage of server resources, etc.

In some implementations, offline smart card use may be facilitated by maintaining a record of when a smart card was last authenticated. Then, the cashless gaming system can ensure that a smart card that has not been recently authenticated is authenticated before further use of the smart card is permitted. Thus, the cashless gaming system may permit offline use of the smart card while ensuring that the smart card is at least occasionally authenticated with one or more cashless gaming servers. The Smart Card Offline Use Validation Procedure 1100 illustrated in FIG. 11 is one example of how offline use of the smart card may be facilitated.

At 1104, the offline window for smart card use is determined. As discussed herein, the offline window may represent, for example, a length of time between the last authenticated use of a specific smart card and the time in which it must be authenticated again before it can be used further. In some implementations, the offline window is 24 hours, which means that if a given smart card has been authenticated with a remote cashless gaming server at a particular time (e.g., during use for a cashless gaming session), that smart card may be used for 24 hours without requiring that the smart card be authenticated again with a remote cashless gaming server. In this way, a player may continue to use a smart card even if remote authentication of the card is not performed.

Configuring the offline window may provide a casino with additional control over security in the cashless gaming system. Thus, according to various implementations, the offline window may be determined in various ways. In some implementations, the offline window may be a value stored on an STM card in communication with the gaming apparatus. For example, the offline window may be stored on an STM card in communication with SIM card slot 136 illustrated in FIG. 1. In some implementations, the offline window may be a value stored on the smart card. For example, the offline window may be stored in wallet module 312 illustrated in FIG. 3. In some implementations, the offline window may be determined dynamically, and/or various offline windows may be used. For example, the gaming machine may read a credit balance stored on the smart card and provide a shortened offline window for a card carrying a relatively high balance than for a card storing a relatively low credit balance.

At 1108, the time of the most recent online use of the smart card may be determined. In some implementations, the most recent online use of the smart card may be the most recent time in which the smart card has been authenticated with one or more remote servers associated with the cashless gaming system (e.g., host systems 124 illustrated in FIG. 1). Authentication of the smart card with one or more remote servers may involve, for example, communication between the smart card and the remote servers to verify that the smart card is intact and has not been tampered with. In addition, or alternately, information related to one or more offline cashless gaming transactions performed using the smart card may be transmitted to the one or more remote servers for verification. For example, information stored on the smart card related to cashless transactions may be transmitted to the one or more remote servers and compared with transaction information received from other devices in the cashless gaming system (e.g., one or more gaming apparatuses associated with the cashless transactions). In this way, cashless transactions performed during offline use of the smart card may be at least periodically verified.

In some implementations, determination of the time of the most recent online use of the smart card may include reading one or more values stored on the smart card. For example, when a smart card is authenticated with one or more remote servers, the one or more remote servers may provide an encrypted token to the smart card (e.g., encrypted with a private key) verifying that the smart card has been authenticated. Then, the smart card may provide this token to the gaming apparatus, which can verify that the token was provided by the one or more remote servers (e.g., by decrypting with the corresponding public key).

At 1112, a determination is made as to whether the most recent online use of the smart card is outside the offline window. The determination may be made by comparing the offline window identified in operation 1104 to the most recent online use of the smart card identified in operation 1108.

At 1116, when it is determined that the last online use of the smart card is outside the offline window, one or more operations related to offline use of the smart card is not permitted. For example, if the smart card has not been validated with the remote server for a period of 3 days, and the window for offline use is 24 hours, offline use of the smart card may not be permitted. In some implementations, no further use of the smart card will be permitted until the smart card is authenticated. However, in some implementations, certain limited uses of the smart card may be permitted. For example, low security operations such as changing the preferred language stored on the smart card may be permitted. As another example, the player may be permitted to finish a partially completed transaction, such as moving credit from a gaming machine to a smart card.

If the gaming apparatus is in communication with one or more cashless gaming servers, the gaming apparatus may automatically initiate communications with the one or more cashless gaming servers for authenticating the smart card. Alternately, or additionally, the gaming apparatus may inform the player that the smart card must be authenticated before further use and/or request that the card be authenticated.

At 1120, when it is determined that the most recent online use of the smart card is inside the offline window, one or more operations related to offline use of the smart card may be permitted. For example, if the offline window is 24 hours, but the smart card was last authenticated 5 hours ago, offline use of the smart card may be permitted.

In some implementations, when the smart card is used in an offline cashless gaming transaction, information related to the cashless gaming transaction may be stored both on the smart card and on the gaming apparatus for later verification (e.g., before cashing out the smart card). In this way, a casino may permit offline use of the smart card while ensuring that the offline transactions are legitimate before providing actual money based on the offline transactions.

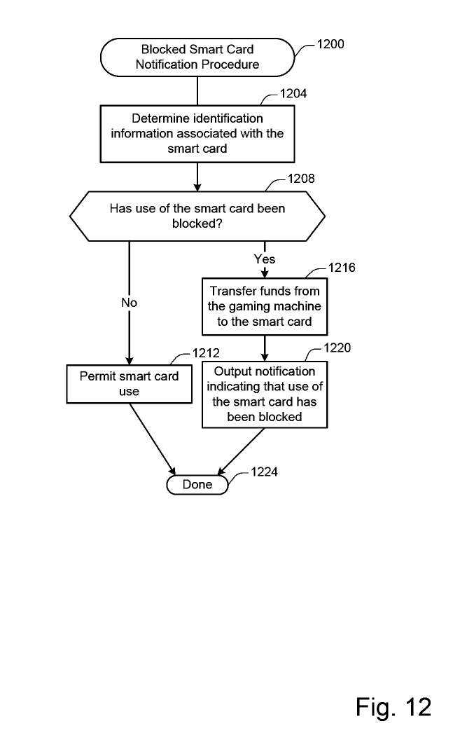

FIG. 12 shows a method 1200 for transmitting a notification regarding a blocked smart card, performed in accordance with one implementation.

In some implementations, the Blocked Smart Card Notification Procedure 1200 may be performed at various devices (e.g., gaming apparatus 104 illustrated in FIG. 1) in communication with a smart card in a cashless gaming system. For example, the Blocked Smart Card Notification Procedure 1200 may be performed at a gaming machine.

The Blocked Smart Card Notification Procedure 1200 may be performed in conjunction with one or more additional procedures associated with use of the smart card. For example, the Blocked Smart Card Notification Procedure 1200 may be performed before one or more of the procedures illustrated in FIGS. 5-11 and 13.

In some implementations, the blocked smart card notification procedure may be used to protect against unauthorized use of a smart card (e.g., a smart card that has been lost or stolen). As another example, the blocked smart card notification procedure 1200 may be used to protect against errors in the case of mismatched smart cards and/or transfer errors.

At 1204, identification information associated with the smart card is determined. According to various implementations, the identification information may include any information that may be used to identify the smart card and/or the user associated with the smart card. For example, the identification may include one or more serial numbers, PINs, player identification numbers, cryptographic keys, etc.

In some implementations, the identification information associated with the smart card may be determined by retrieving one or more values stored on the smart card. For example, one or more values may be retrieved using the Retrieve Smart Card Parameter Value Procedure 500 illustrated in FIG. 5. As a different example, known information regarding the smart card, such as the smart card serial number, may be transmitted to one or more remote servers (e.g., host systems 124 illustrated in FIG. 1) to retrieve additional identification information.

At 1208, a determination is made as to whether the smart card has been blocked. In some implementations, the determination as to whether the smart card has been blocked may be made at the gaming apparatus (e.g., at SMIB 108 illustrated in FIG. 1). In some instances, a gaming apparatus may store information used to identify blocked smart cards. For example, a gaming apparatus may periodically receive a list of blocked smart cards from one or more remote servers. In this way, it may be possible to prevent even certain offline uses of blocked smart cards. Additionally, and/or alternately, a gaming apparatus may directly query one or more remote servers to determine whether a particular smart card has been blocked. In this case, the determination made at 1208 may be made at either the server or at the gaming apparatus.

At 1212, when it is determined that the smart card has not been blocked, continued use of the smart card for cashless gaming may be permitted. For example, funds may be transmitted between the smart card and the gaming apparatus, one or more parameter values stored on the smart card may be retrieved and/or updated, and/or other operations associated with the smart card use may be performed.

At 1216, if instead it is determined that use of the smart card has been blocked, credit is transferred from the gaming apparatus to the smart card. In some implementations, credits may transferred from the gaming apparatus to the smart card using, for example, one or more operations associated with Smart Card Credit Manual Transfer Procedure 700 illustrated in FIG. 7. In a different implementation, one or more different techniques may be used for transferring funds to a blocked smart card.

At 1220, a notification indicating that the smart card has been blocked is output. According to various implementations, the notification may be output via one or more audible and/or visible indicators at the gaming apparatus. For example, the user may be presented with a message on a display (e.g., display 120 illustrated in FIG. 1) indicating that the smart card has been blocked. As another example, a flashing light and/or audible alarm may be activated.

In some implementations, the notification may include one or more instructions. For example, the notification may instruct the user to take the smart card to a different location in the gaming environment, such as a cashier's terminal. In this way, the condition that gave rise to the blocking of the smart card may be resolved. For example, a casino employee may examine one or more transaction records to reconcile or correct a credit transfer error.

In some implementations, notification may be transmitted to one or more casino systems and/or casino employees. For example, notification may be transmitted by an audible and/or visible alarm at the gaming machine. In this way, casino personnel may be notified of a blocked smart card and come to the assistance of the player. As another example, notification may be transmitted over a network. If the smart card was blocked because it was reported lost or stolen, one or more casino employees and/or systems may be notified so that the actual status of the smart card maybe verified. In such instances, a notification indicating that the smart card has been blocked may not be output directly to the user. This may allow casino security to receive the notification and/or direct personnel to identify the user of the blocked smart card.

FIG. 13 shows a method 1300 for cashing out a missing smart card, performed in accordance with one implementation. In some implementations, missing smart card cash out procedure 1300 may be used to retrieve funds stored on a smart card that is lost, stolen, or otherwise missing. For example, a user who notices that their smart card is missing may report the loss to one or more casino employees and/or systems (e.g., at a patron management and/or cashier's terminal). Then, the Missing Smart Card Cash Out Procedure 1300 may be used to insure that all transactions completed using the missing smart card have been recorded and/or verified before transferring credit stored on the smart card.

At 1304, a request is received to remove cash from the missing smart card. For example, the request may be received by one or more of the user, the cashier, and/or a program associated with cashless gaming. In some implementations, a request was received at a cashier's terminal.

At 1308, a determination is made as to whether the use of the smart card has been blocked. In some implementations, the determination made at 1308 may be substantially similar to the operations described with respect to reference number 1208 illustrated in FIG. 12.

At 1312, if it is determined that the smart card has not been blocked, use of the smart card may be blocked. In some implementations, the use of the smart card is blocked by transmitting instructions to one or more remote servers associated with cashless gaming. In this way, further use of the smart card for cashless gaming may be prevented until the status of the smart card may be determined.

In some implementations, the instructions transmitted to the one or more remote servers may include identification information associated with the player making the request to remove cash from the missing smart card. The information may include personal identification information, such as name, date of birth, address, or any other type of information. Collecting and transmitting such information may assist in preventing players from making fraudulent requests to remove cash from smart cards (e.g., smart cards that are not their own).

At 1316, when it is determined that use of the smart card has been blocked, the offline window for smart card is determined. In some implementations, determining the offline window for smart card use as illustrated at 1316 may be substantially similar to operation 1104 illustrated in FIG. 11.

At 1320, a determination is made as to when the smart card was blocked. In some implementations, the determination as to whether the smart card was blocked may be made by transmitting a request to one or more remote systems, such as host systems 124 illustrated in FIG. 1. Additionally, and/or alternately, the gaming apparatus may maintain a list of blocked smart cards transmitted periodically from one or more remote servers, along with time stamps indicating when each card was blocked.

At 1324, a determination is made as to whether the time when the smart card was blocked falls outside the offline window associated with the smart card. The determination may be made by comparing the offline window identified in operation 1316 to the time at which use of the smart card was blocked as determined at operation 1320. In some implementations, a message indicating that the smart card is blocked may be transmitted to the smart card. If a response message is received from the smart card indicating that the smart card has acknowledged that the smart card is blocked, then funds associated with the smart card may be safely provided to the player.

At 1328, when it is determined that the time in which the smart card was blocked falls outside the offline window for smart card use, one or more operations may be performed for cashing out and invalidating the smart card. For example, the player may be provided with actual cash corresponding to a verified balance stored on the smart card. As another example, the player may be provided with a new smart card storing a credit balance. In addition, or alternately, further use of the blocked smart card may be permanently prevented.

In some instances, a smart card may become blocked by the cashless gaming system due to a mismatch between one or more balances or transaction records stored on the smart card and one or more balances or transactions records stored at a cashless gaming server. Such a mismatch may occur, for instance, if gaming machine electronics became permanently disabled before a transaction could be transmitted to the server. Accordingly, a cashless gaming system may enforce security policies to handle mismatches.

For example, one security policy may be that a user (e.g., a casino employee) cannot permanently clear a system block (e.g., due to a mismatch in the transaction records). Thus, a casino employee with appropriate security clearances may be able to access information stored on a block smart card. However, the smart card may remain blocked until the system block is cleared by the cashless gaming system itself, for example by reconciling the mismatched transaction records.

As another example, one security policy may be that writing to a card to modify the transaction record is prohibited by the system and/or physically impossible. If there is a transaction recorded in the database but not on a smart card, for instance, then it is likely that the smart card either is malfunctioning or has been tampered with. In such a scenario, a casino may choose to issue a new card, but the mismatched card may remain blocked and unaltered in order to retain a clear record of any transactions. Additionally, or alternately, a casino employee (e.g., a cashier) may read the last known balance from the database and/or smart card and make an operational choice as to the amount of funds to provide the player upon cash-out.

As yet another example, one security policy may be that only certain casino personnel (e.g., supervisors) have permission to modify a transaction database at a cashless gaming server. The casino may know, for instance, that a specific slot machine overloaded and became inoperable. Therefore, the casino may choose to honor transactions that were stored on the smart card but not recorded on the cashless gaming server. This may be accomplished by manually modifying the transactions database on the cashless gaming server to match the transaction record on the smart card.

FIG. 17 shows a block diagram of a system architecture 1700 for facilitating smart card transactions, configured in accordance with one implementation. In some implementations, the system architecture 1700 may allow a smart card to communicate directly with an EGM operating system via a smart card interaction device. The EGM may act as a gateway for the smart card interaction device to communicate with one or more smart card hosts.

The system architecture 1700 includes an EGM 1702, an ID reader host 1704, a smart card host 1706, and a G2S network link 1708. The EGM 1702 includes an operating system 1710, a user interface 1712, a credit meter 1714, an extension class module 1716, and a G2S network interface 1718. The operating system 1710 communicates with card reader hardware 1720 via an internal bus protocol 1728. The card reader hardware 1720 includes a card reader 1722, a smart card 1724, and a bezel 1726.

In some implementations, the EGM 1702 may be any electronic gaming machine capable of facilitating wager-based gaming. Additional details regarding EGMs are described, for example, with respect to FIG. 14.

In some implementations, the EGM 1702 may communicate with other devices, such as servers, via a network. Communications via the network may be conducted in accordance with a messaging communication protocol, such as the G2S messaging communication protocol 1708. However, communications need not be conducted only via G2S. Instead, any suitable communication protocol for communication between the EGM and other computing devices may be used.

In some implementations, the ID reader host 1704 may be configured to perform operations related to validating a player's identity. For instance, an ID reader host may be configured to resolve a code from a magnetic stripe of a mag-card into a player account number. Based on the player account number, the ID reader host may direct the EGM to start a player session. The player session may then be tracked and reported by the EGM. In this way, different hosts may be configured for handling identification tasks and smart card tasks. Alternately, an ID reader host may not be included in some implementations. For example, a smart card may include information for identifying a player, and such information may be used in some implementations apart from the ID reader host 1704.

In some implementations, the smart card host 1706 is configured to perform operations for facilitating smart card transactions. For example, the smart card host 1706 may perform operations as described with respect to FIGS. 7-10 and 21-26. In some instances, the smartCard host may be involved with credit transfers. Alternately, the EGM and card reader may handle credit transfers on their own and just report the results to the smartCard host for logging and audit. This may allow for continuing smartCard functions when the host is unavailable to the EGM.

In some implementations, the EGM operating system 1710 may be responsible for managing the operating of the hardware and other software operating at the EGM, as well as communication between the EGM and other devices via a network interface. For example, the EGM operating system 1710 may act as a gateway between one or more hosts in communication with the EGM via a network and one or more smart card interaction devices at the EGM. In this capacity, the EGM operating system 1710 may forward messages from a smart card interaction device to a host and forward messages from the host to the smart card interaction device.

In some implementations, the EGM operating system 1710 may facilitate balance transfers between the credit meter 1714 and the smart card 1724. For example, the EGM 1710 may receive a request from the smart card 1724 to transfer funds from the smart card 1724 to the credit meter 1714. As another example, the EGM 1710 may initiate a transfer of funds from the credit meter 1714 to the smart card 1724 at the request of a player at the EGM.

In some implementations, the EGM operating system 1710 may facilitate interaction between a player and the smart card 1724 by providing access to the user interface 1712. The user interface 1712 may allow a player to perform transactions related to the smart card, as discussed for example with respect to FIGS. 4-13 and 20-26.

In some implementations, the user interface 1712 may be presented on dedicated user interface hardware. The hardware may include components such as a display, a touch screen, a keypad, or a button panel. The hardware may be located within the cabinet of the gaming machine 1702. Alternately, the hardware may be located outside the cabinet of the gaming machine. In some cases, the hardware may be used to provide user interface functionality for other types of interactions with the gaming machine, such as player tracking.

In some implementations, the user interface 1712 may be linked directly to the card reader hardware 1720. For instance, the card reader hardware 1720 may include a display screen, button panel, touch pad, or other such hardware.

In some implementations, the user interface 1712 may be presented within the gaming machine user interface. For instance, the user interface 1712 may be presented in conjunction with a user interface for playing a game at the gaming machine. In this case, the user interface 1712 may be integrated into the gaming machine operating system 1710. In one example, the user interface 1712 may be presented on a display screen associated with the EGM 1702. User input may be received via the screen itself if the display screen is a touch screen. Alternately, or additionally, user input may be received via an input device associated with the gaming machine, such as a keypad or button panel.

In some implementations, the user interface 1712 may be presented within an externally-controlled interface (ECI), which may also be referred to as a service window. Devices on the gaming machine may be controlled by software executed by a master gaming controller on the gaming machine in conjunction with software executed by a remote logic device (e.g., a remote host, a central server or a central controller) in communication with the gaming machine. The master gaming controller may execute externally-controlled interface (ECI) processes that enable content generated and managed on the remote host to be output on the gaming machine. The gaming machine may receive and send events to the remote host that may affect the content output by one or more ECI processes as well as enable an ECI process to be initiated on the gaming machine. The ECIs may be executed while a gaming machine is operable to provide play of a wager-based game of chance. During operation, one or more games and one or more executed simultaneously, one or more games may be executed without execution of an ECI or one or more ECIs may be executed while a game is not being played. Therefore, the resources may be limited to ensure that a gaming experience on the gaming machine is optimal while access to gaming resources is granted to a remote host.

In some implementations, an ECI may be used to generate a user interface in an area of a display device. When controlled by the ECI, the area of the display may output video data and receive user input under the direction of an external source such as a remote host or central server. For instance, the ECI may display credit balance information and receive smart card user input commands associated with the smart card. Messages may be passed between the smart card reader hardware 1720 and the ECI through the gaming machine operating system 1710. Thus, user interface hardware already at the EGM may be used to control the smart card and view smart card-related information. However, since the ECI may execute a process that is in some ways independent of the EGM operating system 1710, the EGM operating system can be made to remain unaware of the smart card balance and other such smart card information. Further, the EGM operating system 1710 need not be modified based on a particular smart card security model or implementation details, but rather can simply pass messages between the smart card reader hardware 1720 and the ECI. Additional details regarding ECIs are discussed in co-pending and commonly assigned U.S. patent application Ser. No. 11/595,774, titled “METHOD AND APPARATUS FOR INTEGRATING REMOTELY-HOSTED AND LOCALLY RENDERED CONTENT ON A GAMING DEVICE”, filed Nov. 10, 2006, by LeMay et al., which is incorporated herein by reference in its entirety and for all purposes.

In some implementations, the credit meter 1714 may maintain one or more credit balances for wager-based gaming at the gaming machine. In some instances, only a single credit balance may be maintained. Alternately, separate credit balances may be maintained for different types of funds. For example, a cash credit balance may be maintained separately from a smart card credit balance. By maintaining separate credit balances, smart card transactions may be separated from cash transactions and other types of transactions to facilitate accounting or transaction verification. For example, as discussed with respect to FIG. 11, smart card transactions may be conducted while the EGM is not in communication with the smart card host 1706. Credits may be moved between the credit meter 1714 and the smart card 1724 according to various techniques described herein.

In some implementations, the extension class module 1716 may include computer programming language extending the functionality of an underlying messaging protocol, such as G2S. For example, the extension class module may include an extension class for performing operations related to facilitating communication between the card reader hardware 1720, the smart card host 1706, and various devices at the EGM 1702, as described herein. As another example, the extension class module may include an extension class for implementing an idReader configured to perform operations related to verifying a player's identity.

In some implementations, the G2S messaging protocol interface 1718 defines the procedures for the EGM to use when communicating via a network using the G2S messaging protocol 1708. The G2S messaging protocol interface may be defined using computer programming language instructions and may be loaded by the EGM operating system 1710 upon startup of the EGM or at any other time.

In some implementations, a messaging protocol other than G2S, such as SAS, may be used. In this case, a messaging protocol interface may be loaded that corresponds to the messaging protocol in use.

In some implementations, the card reader hardware 1720 may contain any devices capable of facilitating transactions involving the smart card 1724. For example, the card reader hardware 1720 may contain a smart card interaction device (also referred to herein as a card reader), a user interface component for interacting with a smart card, and other such devices.

In some implementations, all or a portion of the card reader hardware 1720 may be contained within the EGM. Alternately, at least some of the card reader hardware 1720 may be located outside the EGM. For instance, a smart card interaction device may be mounted on the outside of the EGM cabinet or in some other location.

In some implementations, the card reader 1722 may be any type of smart card interaction device capable of communicating with the EGM. Details related to the types of card readers that may be used are discussed, for example, with respect to the card reader 112 shown in FIG. 1.

In some implementations, the smart card 1724 may be any type of smart card capable of communicating with the card reader 1722. Details related to the types of smart cards that may be used are discussed, for example, with respect to FIGS. 2-4.

In some implementations, the bezel 1726 may provide a physical barrier to accessing the card reader 1722. The bezel may provide structural support for the card reader 1722 and other card reader hardware 1720. For example, the bezel may contain a display or user interface component for facilitating interaction with the smart card 1724 via the card reader 1722.

In some implementations, the bezel may be lighted and/or translucent. The EGM may be capable of setting the bezel to one or more of several colors, such as red, orange, green, blue, and purple. The card reader hardware may incorporate lighted bezel functions. For instance, the color of the bezel may be changed based on a smart card operation.

In some implementations, the operating system may communicate with the card reader hardware 1720 via an internal bus protocol 1728. The internal bus protocol may be any protocol suitable for facilitating communications with peripheral devices at the EGM. For example, the internal bus protocol may operate over a USB, serial, or other peripheral connection.

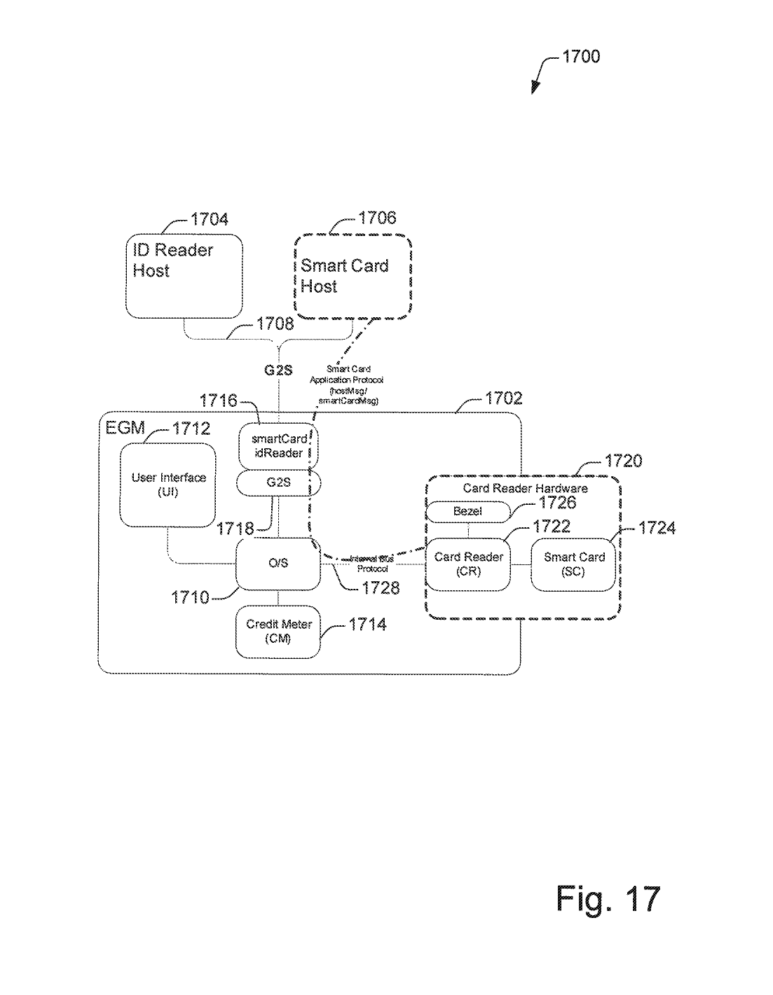

In some implementations, communication between the operating system 1710 and the card reader hardware 1720 via the internal bus protocol 1728 may be conducted in accordance with a device driver for the card reader hardware 1720 accessible to the EGM operating system. Additional details regarding device drivers are discussed with respect to operation 1802 shown in FIG. 18.

FIG. 18 shows a flowchart of a method 1800 for starting a smart card interface, performed in accordance with one implementation. In some implementations, the method 1800 may be performed within an EGM. For instance, the method 1800 may be performed at least in part by the EGM operating system. The method 1800 may be performed when the operating system is initialized, when the gaming machine is started, when a smart card interaction device is activated or enabled, or at any other time. By performing the method 1800, the EGM may be made capable of communicating with one or more smart card interaction devices and of facilitating communication between smart card interaction devices and one or more remote host servers.

At 1802, the smart card interaction devices device drivers are loaded into the EGM operating system. In some implementations, a smart card interaction device driver may provide machine readable instructions for communicating with a particular type of smart card interaction device. The drivers may provide instructions for creating messages to send to the smart card interaction device as well as instructions for parsing messages received from the smart card interaction device.

In some implementations, the smart card interaction device drivers may be retrieved from a local storage medium at the EGM. Alternately, or additionally, smart card interaction device drivers may be retrieved via a network.

In some implementations, all available smart card interaction device drivers available to the EGM may be loaded. Alternately, only some smart card interaction device drivers may be loaded, such as the drivers for smart card interaction devices connected to the EGM.

At 1804, one or more smart card interaction devices in communication with the EGM are identified. In some implementations, the smart card interaction devices may be included within the EGM, as discussed with respect to various devices shown in FIG. 14. Alternately, the smart card interaction devices may be in communication with the EGM, for example via wireless communication.

In some implementations, the smart card interaction devices may be identified by identifying messages received at the EGM from peripheral devices and analyzing those messages to determine if any of the messages were sent from a smart card interaction device. Alternately, or additionally, the smart card interaction devices may be identified by querying communication interfaces accessible to the EGM to determine whether any smart card interaction devices are present. In some instances, no smart card interaction devices may be identified. Alternately, one, two, or any supported number of smart card interaction devices may be identified.

At 1806, the messaging communication protocol interface is started. In some implementations, the messaging communication protocol interface may provide a mechanism for the EGM to communicate with devices in communication with other devices in communication with the EGM. For example, the EGM may communicate with a host server via a network, with another EGM, with peripheral devices, or with any other type of device.

In one implementation, the messaging communication protocol may be the Game-to-System (G2S) protocol promulgated by the Gaming Standards Association. Other messaging communication protocols that may be used may include, but are not limited to: the Slot Accounting System (SAS), System-to-System (S2S), Gaming Device Standard (GDS), Best of Breed (BOB), British Amusement Catering Trade Association (BACTA), Queensland Local Area EGM Communications (QCOM) protocols.

In some implementations, starting the messaging communication protocol interface may include initiating a program for using the messaging communication protocol within the EGM. Alternately, or additionally, a description of the messaging communication protocol may be retrieved for use by the EGM OS.

In some implementations, only one messaging communication protocol interface may be loaded. Alternately, two or more messaging communication protocol interfaces may be loaded to facilitate communication by the EGM according to a plurality of messaging communication protocols.

In some implementations, starting the messaging communication protocol interface may include loading an extension class describing a protocol for communications related to the smart card. The smart card extension class may describe the form and/or the content of messages transmitted to and received from smart card interaction devices For example, the smart card extension class may describe the EGM's role in the methods shown in FIGS. 5-13 and 18-26.

At 1808, the status of the smart card interaction devices at the EGM is determined. In some implementations, the status of the smart card interaction devices may be determined by communicating with each smart card interaction device as defined in the device driver associated with the smart card interaction device. The communication with each smart card interaction device may be conducted as part of the identification of the smart card interaction devices at operation 1804 or may be independently conducted.

In some implementations, status information may be received from the smart card interaction device. For instance, a smart card interaction device may send a message to the EGM indicating an error condition at the smart card interaction device.

In some implementations, status information may be determined at the EGM. For instance, the EGM may initially detect a smart card interaction device in communication with the EGM and later determine that the smart card interaction device has stopped communicating with the EGM. Based on this sequence of events, the EGM may determine that an error condition exists in the smart card interaction device.

In some implementations, the status information may include an error condition detected in the smart card interaction device. For instance, the smart card interaction device may determine that a smart card has lodged in the smart card interaction device. As another example, the smart card interaction device may send a message indicating that the smart card interaction device has been tampered with and thus should not be treated by the EGM as a trusted device.

In some implementations, the status information may identify a capability of the smart card interaction device. For instance, the status information may specify that the smart card interaction device is capable of near field radio communications.

In some implementations, the status information may identify whether the smart card interaction device is currently in communication with any smart cards.

At 1810, the EGM initiates a communication session with one or more host servers. In some implementations, a host server may provide instructions or services to the EGM. In some implementations, a host server may act as a portal for the EGM. The portal may assign the EGM, or certain units of functionality at the EGM, to other host servers. For instance, the portal may assign the EGM to a particular host server for purposes of conducting communications involving a smart card.

In some implementations, the EGM may transmit information to a host server. For example, the EGM may transmit information identifying capabilities of the EGM. This information may identify, for instance, any smart card interaction devices identified at operation 1804. In addition, the EGM may transmit some or all of the status information determined at operation 1808. As another example, a host server may store accounting or transaction information received from the EGM.

In some implementations, the EGM may receive information from a host server. For example, a host server may provide configuration information, such as which games to activate, to the EGM.

In some implementations, a host server may process and validate transactions involving a smart card. The host server may be, for example, the smart card host 1706 shown in FIG. 17. The host server may participate in smart card transactions as discussed with respect to the methods shown in FIGS. 5-13 and 18-26.

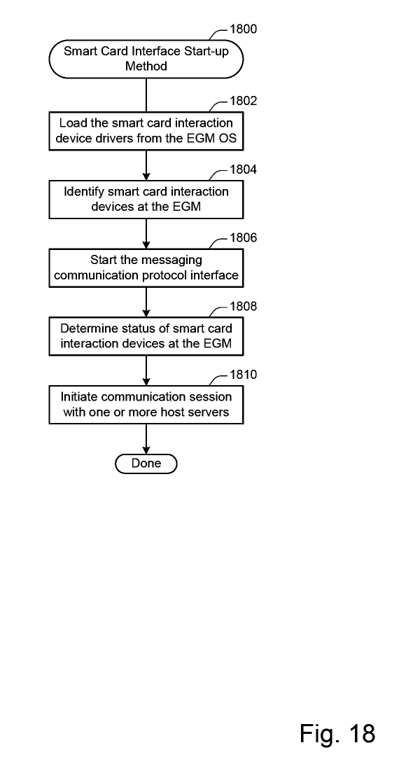

FIG. 19 shows a flow diagram of a method 1900 for a smart card interface runtime, performed in accordance with one implementation. In some implementations, the method 1900 may be performed within an EGM. For instance, the method 1900 may be performed at least in part by the EGM operating system. The method 1900 may be performed when a smart card interaction device is activated or enabled after the EGM is already running and in communication with a host. For example, the method 1900 may be performed after communication is established via the messaging communication protocol initiated in operation 1806 shown in FIG. 18. By performing the method 1900, the EGM may be made capable of communicating with one or more smart card interaction devices and of facilitating communication between smart card interaction devices and one or more remote host servers.

At 1902, the smart card interaction device is activated at the EGM. In some implementations, activation of the smart card interaction device may include an operation for physically connecting the smart card interaction device to the EGM. For example, a new smart card interaction device may be installed in the EGM and connected to a communication port (e.g., a USB port, a serial port) within the EGM. As another example, a hardware power switch may be activated to power up a smart card interaction device that is already physically connected to the EGM.

In some implementations, activation of the smart card interaction device may include an operation for enabling use of the smart card interaction device in software. For example, a menu selection enabling a previously disabled smart card interaction device may be made within the EGM operating system.

At 1904, the status of the smart card interaction device is determined within the EGM operating system. In some implementations, the operation 1904 may be substantially similar to the operation 1808 discussed with respect to FIG. 18.

At 1906, the host server is notified of a change in capabilities at the EGM. In some implementations, notifying the host server may include sending the host server at least a portion of the status information determined at 1904. By notifying the host server of the addition of the smart card interaction device to the EGM, the host server may be prepared to facilitate smart card transactions via the newly activated smart card interaction device.

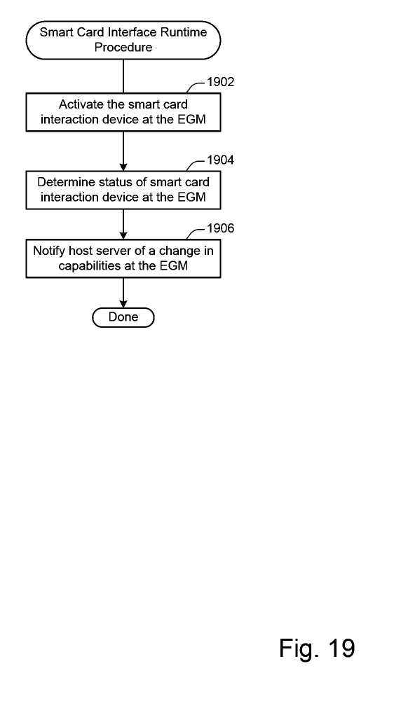

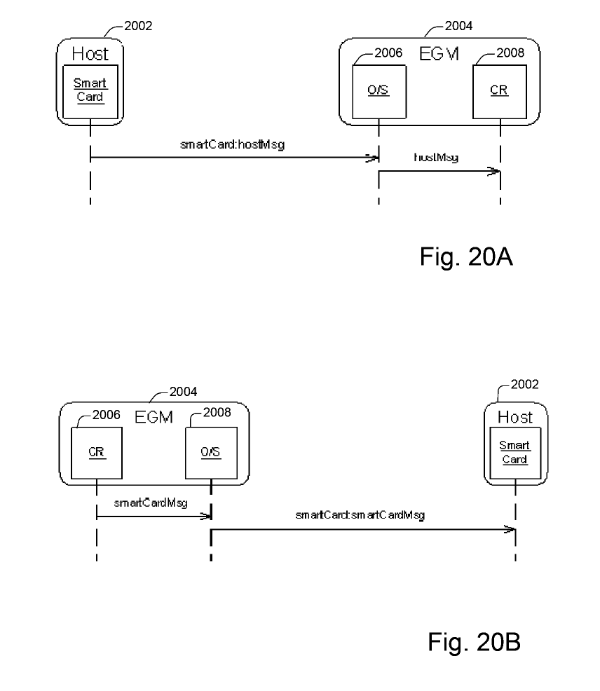

FIGS. 20A-26 show message passing diagrams of messages passed between system components, configured in accordance with one implementation. FIGS. 20A and 20B include a smart card host 2002 and an EGM 2004. The EGM includes an operating system 2006 and a card reader 2008.

In some implementations, the smart card host 2002 may be any server configured to communicate with the EGM 2004 via a network and configured to perform operations related to a smart card. For instance, the smart card host 2002 may be substantially similar to the smart card host 1706 discussed with respect to FIG. 17. The EGM 2004, operating system 2006, and card reader 2008 may be substantially similar to the components 1702, 1710, and 1720 discussed with respect to FIG. 17.

FIG. 20A shows a message passing diagram for transmitting a message from the smart card host 2002 to a smart card, configured in accordance with one implementation. In some implementations, the smart card host 2002 may transmit a message to the EGM operating system 2006 via a network. The message may be constructed in such a way that the gaming machine operating system 2006 can determine that the message is addressed to the card reader. When the gaming machine operating system 2006 receives the message, the operating system forwards the message to the card reader 2008.

FIG. 20B shows a message passing diagram for transmitting a message from the smart card to the smart card host 2002, configured in accordance with one implementation. In some implementations, a message from the smart card may be received at the card reader 2008. This message may then be transmitted from the card reader 2008 to the gaming machine operating system 2006. When the message is received at the gaming machine operating system 2006, the operating system may forward the message to the smart card host 2002. The forwarded message may be constructed in such a way that the smart card host 2002 can identify the source as the smart card in communication with the card reader 2008 at the EGM 2004.

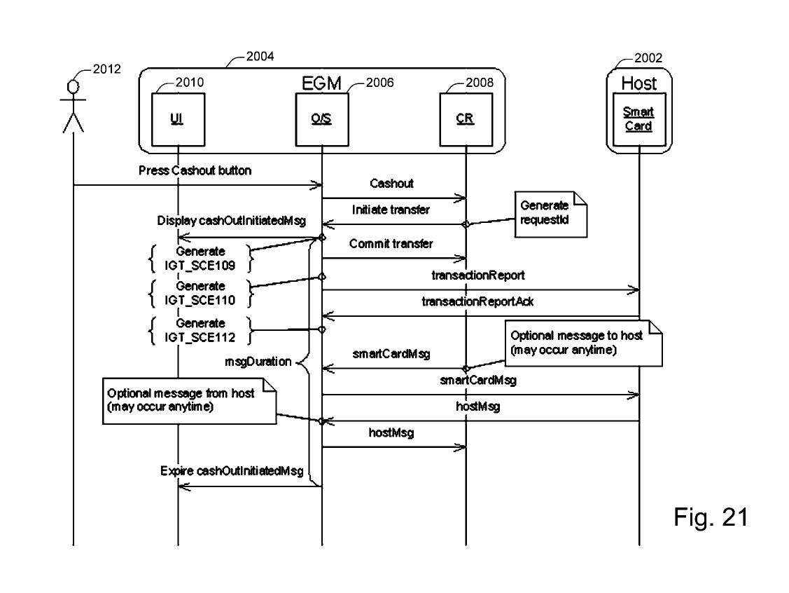

FIG. 21 shows a message passing diagram for cashing out an EGM credit meter of an EGM in communication with a smart card via a smart card reader at the EGM, configured in accordance with one implementation. FIG. 21 includes the smart card host 2002, the EGM 2004, the EGM operating system 2006, and the card reader 2008 discussed with respect to FIG. 20. Additionally, FIG. 21 includes an EGM user interface 2010 and a player 2012.

In some implementations, the message passing diagram shown in FIG. 21 may be used in conjunction with the cashout procedure 900 shown in FIG. 9. For instance, messages transmitted between various components as discussed with respect to FIG. 9 may be passed between these components as shown in FIG. 21. Alternately, the message passing diagram shown in FIG. 21 may be used in conjunction with a different procedure.

In some implementations, the player 2012 may press a cashout button located at the EGM. An indication of this button press may be received by the EGM operating system 2006. When the EGM operating system receives the request to cashout, the operating system may transmit a message requesting a cashout to the card reader 2008. The card reader may generate a request identifier that identifies the cashout request. This identifier may be included in subsequent messages related to the cashout request.

In some implementations, the card reader 2008 may initiate the cashout request by transmitting a message to the gaming machine operating system 2006. The operating system may then cause a message indicating that the cashout has been initiated to be displayed on the EGM user interface 2010. This message may be displayed while the cashout procedure continues.

In some implementations, the gaming machine operating system 2006 may transmit a message to the smart card reader 2008 indicating an amount of funds to transfer to the smart card. The operating system 2006 may also transmit a message to the smart card host 2002 that includes the request identifier, the amount transferred to the smart card, and any other relevant information. This message may be acknowledged by a response message transmitted by the smart card host 2002.

In some implementations, the smart card may transmit a message via the smart card reader 2008 to the gaming machine operating system 2006 during the cashout procedure. The gaming machine operating system 2006 may forward the message to the smart card host 2002. The message may include the request identifier identifying the cashout procedure that is occurring, as well as any other information.

In some implementations, the smart card host 2002 may transmit a message to the gaming machine operating system 2006 during the cashout procedure. The gaming machine operating system 2006 may forward this message to the smart card via the smart card reader 2008. The message may include the request identifier identifying the cashout procedure that is occurring, as well as any other information. Messages transmitted between the host 2002 and the smart card reader 2008 may be used to facilitate the cashout process.

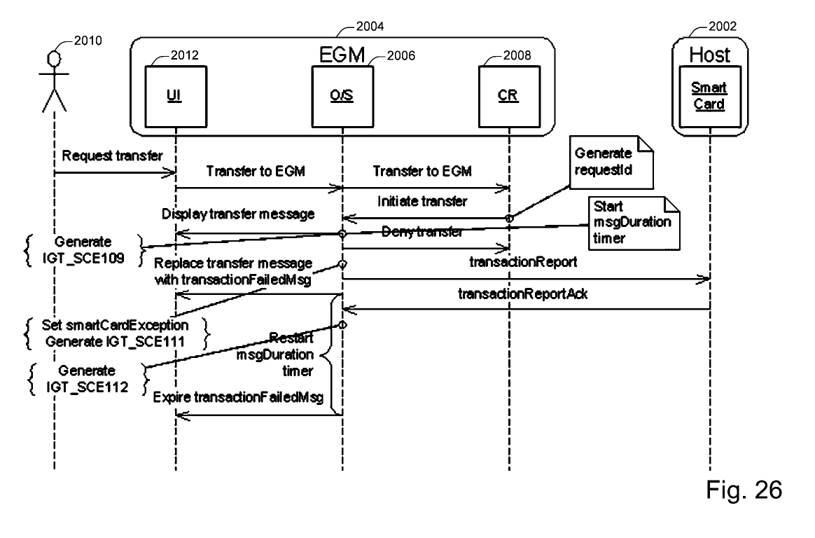

In some implementations, when the cashout procedure is terminated, the gaming machine operating system 2006 may transmit a message to the user interface 2010. The message transmitted to the user interface 2010 may indicate that the message duration timer has expired. At this point, the cashout message displayed on the user interface 2010 may be removed. If an error should occur, then the flow of FIG. 26 may apply.

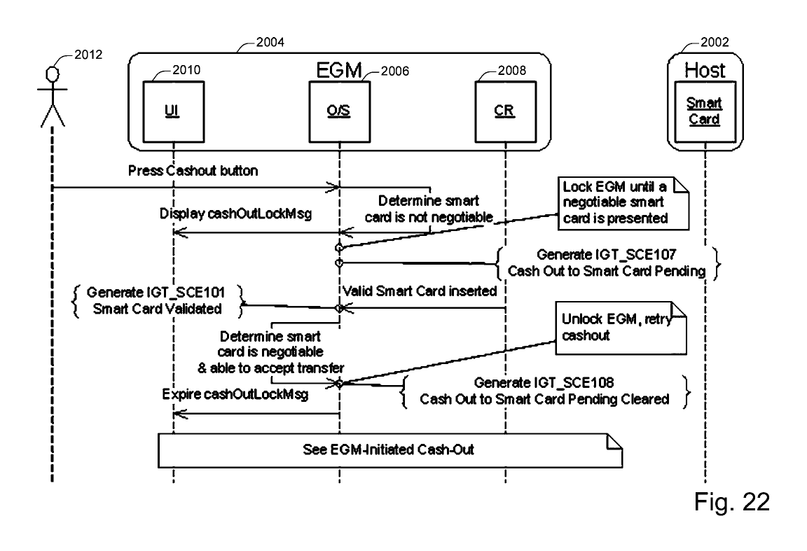

FIG. 22 shows a message passing diagram for cashing out a smart card, configured in accordance with one implementation. FIG. 22 includes the smart card host 2002, the EGM 2004, the EGM operating system 2006, the card reader 2008, the EGM user interface 2010 and the player 2012 discussed with respect to FIG. 21.

In some implementations, the message passing diagram shown in FIG. 22 may be used in conjunction with the cashout procedure 900 shown in FIG. 9. For instance, messages transmitted between various components as discussed with respect to FIG. 9 may be passed between these components as shown in FIG. 22. Alternately, the message passing diagram shown in FIG. 22 may be used in conjunction with a different procedure.

In some implementations, the player 2012 may press a cashout button located at the EGM. An indication of this button press may be received by the EGM operating system 2006. When the EGM operating system receives the request to cashout, the operating system may determine whether the card reader 2008 is in communication with a valid smart card. In some instances, this determination may involve communication between the operating system 2006 and the card reader 2008. Alternately, the operating system 2006 may already possess this information.

In some implementations, when a determination is made by the operating system 2006 that a valid smart card is not present, the operating system 2006 may cause the user interface 2010 to display a message indicating that the cashout is locked until a valid smart card is provided to the gaming machine via the smart card reader 2008. At this point, the gaming machine may be locked from further use.

In some implementations, a valid smart card may then be provided to the card reader 2008. When the card is validated, a message may be transmitted to the operating system 2006. The operating system 2006 may determine that the smart card is negotiable and able to accept the balance transfer necessary to complete the requested cashout operation. At this point, the gaming machine may be unlocked in order to retry the requested cashout operation.

In some implementations, the operating system 2006 may then cause the user interface 2010 to stop displaying the message indicating that the gaming machine is locked. The requested cashout operation may then be resumed. For instance, the requested cashout operation may be completed as described with respect to FIGS. 21 and 9.

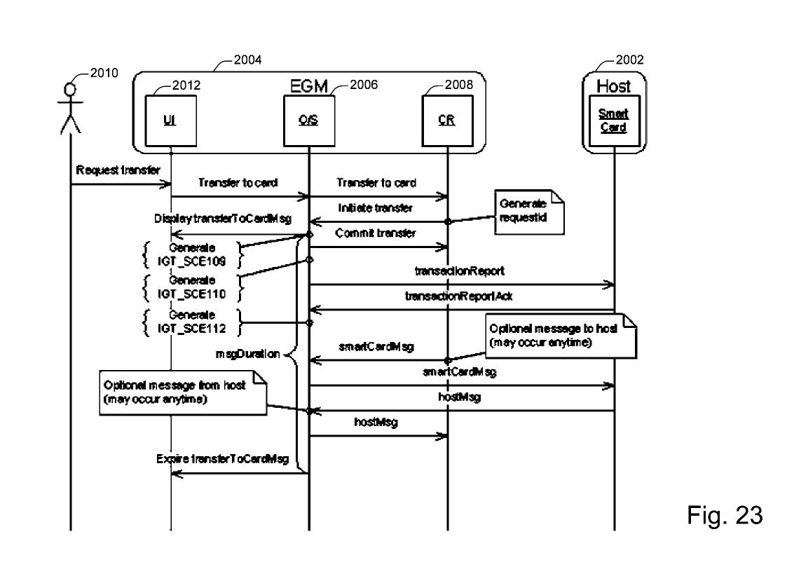

FIG. 23 shows a message passing diagram for transferring a balance from an EGM to a smart card, configured in accordance with one implementation. FIG. 23 includes the smart card host 2002, the EGM 2004, the EGM operating system 2006, the card reader 2008, the EGM user interface 2010 and the player 2012 discussed with respect to FIG. 21.

In some implementations, the message passing diagram shown in FIG. 23 may be used in conjunction with the transfer procedure 700 shown in FIG. 7. For instance, messages transmitted between various components as discussed with respect to FIG. 7 may be passed between these components as shown in FIG. 23. Alternately, the message passing diagram shown in FIG. 23 may be used in conjunction with a different procedure.

In some implementations, the player 2012 may initiate a request at the EGM user interface 2012 to transfer funds from the EGM to a smart card in communication with the card reader 2008. The user interface 2012 may transmit this request to the operating system 2006, which may transmit the request to the card reader 2008. The card reader may generate a request identifier, as discussed with respect to FIG. 21, and transmit a message initiating the transfer to the gaming machine operating system 2006.

In some implementations, the operating system 2006 may then cause the user interface 2012 to display a message indicating that a transfer is occurring. The message may remain on the user interface 2012 while the transfer completes.

In some implementations, the operating system 2006 may transmit a message to the card reader 2008 causing the funds transfer to occur. As discussed with respect to FIG. 21, this and other messages may include the request identifier to identify the transaction that is occurring.

In some implementations, the operating system 2006 may transmit a message to the smart card host 2002 reporting the transaction. The smart card host may acknowledge the transaction in a response message transmitted to the operating system 2006.

In some implementations, the smart card may transmit a message via the smart card reader 2008 to the gaming machine operating system 2006 during the transfer procedure. The gaming machine operating system 2006 may forward the message to the smart card host 2002. The message may include the request identifier identifying the transfer procedure that is occurring, as well as any other information.

In some implementations, the smart card host 2002 may transmit a message to the gaming machine operating system 2006 during the transfer procedure. The gaming machine operating system 2006 may forward this message to the smart card via the smart card reader 2008. The message may include the request identifier identifying the transfer procedure that is occurring, as well as any other information. Messages transmitted between the host 2002 and the smart card reader 2008 may be used to facilitate the transfer process.

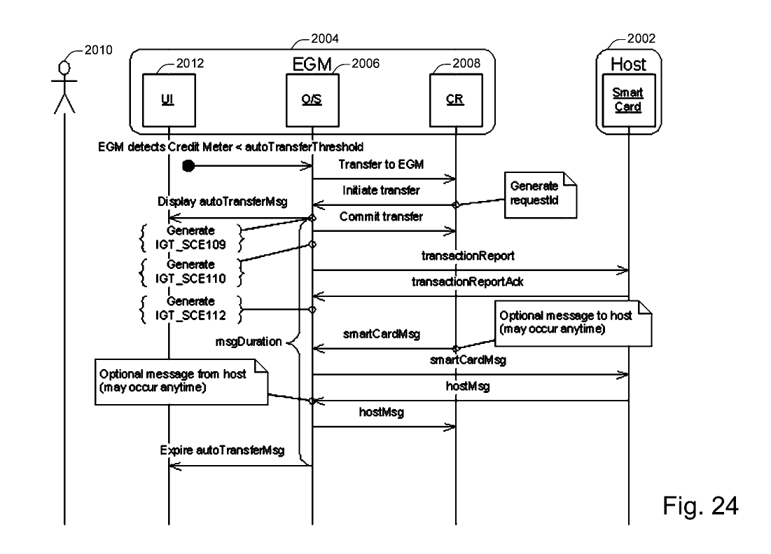

FIG. 24 shows a message passing diagram for automatically transferring a balance from a smart card to an EGM, configured in accordance with one implementation. FIG. 24 includes the smart card host 2002, the EGM 2004, the EGM operating system 2006, the card reader 2008, the EGM user interface 2010 and the player 2012 discussed with respect to FIG. 21.

In some implementations, the message passing diagram shown in FIG. 24 may be used in conjunction with the auto-transfer procedure 800 shown in FIG. 8. For instance, messages transmitted between various components as discussed with respect to FIG. 8 may be passed between these components as shown in FIG. 24. Alternately, the message passing diagram shown in FIG. 24 may be used in conjunction with a different procedure.

In some implementations, the EGM may detect that a credit meter is below an auto transfer threshold. The gaming machine operating system 2006 may then automatically initiate a transfer procedure from the smart card by transmitting a message requesting a transfer of funds to the EGM's credit meter.

In some implementations, the remaining messages passed in the diagram shown in FIG. 24 may be substantially similar to those discussed with respect to FIG. 23.

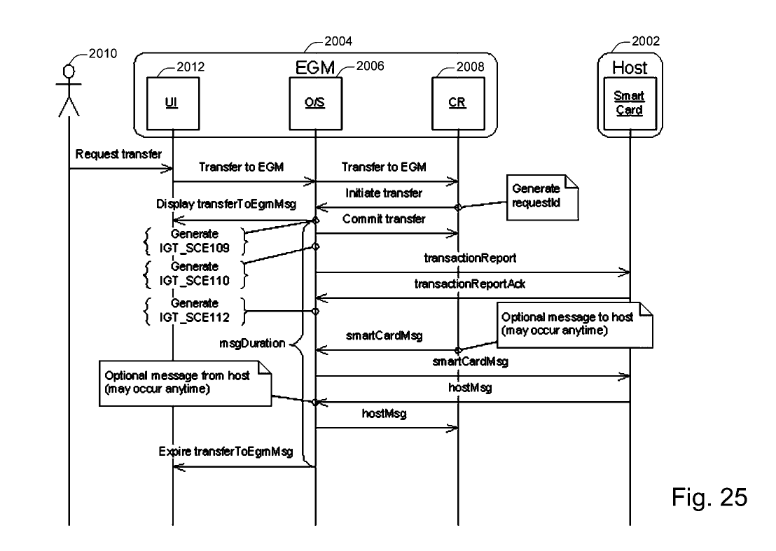

FIG. 25 shows a message passing diagram for transferring a balance from a smart card to an EGM, configured in accordance with one implementation. FIG. 25 includes the smart card host 2002, the EGM 2004, the EGM operating system 2006, the card reader 2008, the EGM user interface 2010 and the player 2012 discussed with respect to FIG. 21.

In some implementations, the message passing diagram shown in FIG. 25 may be used in conjunction with the transfer procedure 700 shown in FIG. 7. For instance, messages transmitted between various components as discussed with respect to FIG. 7 may be passed between these components as shown in FIG. 25. Alternately, the message passing diagram shown in FIG. 25 may be used in conjunction with a different procedure.

In some implementations, a request to transfer funds from the smart card to the EGM may be received at the user interface 2012. The user interface 2012 may then transmit this request to the operating system 2006, which may forward the request to the card reader 2008. The card reader may generate a request identifier, as discussed with respect to FIG. 21, and transmit a message initiating the transfer to the gaming machine operating system 2006. The remainder of the messages shown in the message passing diagram shown in FIG. 25 may be substantially similar to the messages described with respect to FIGS. 23 and 24.

FIG. 26 shows a message passing diagram for a failed attempt to transfer a balance from a smart card to an EGM, configured in accordance with one implementation. FIG. 24 includes the smart card host 2002, the EGM 2004, the EGM operating system 2006, the card reader 2008, the EGM user interface 2010 and the player 2012 discussed with respect to FIG. 21.

In some implementations, the message passing diagram shown in FIG. 26 may be used in conjunction with the transfer procedure 700 shown in FIG. 7. For instance, messages transmitted between various components as discussed with respect to FIG. 7 may be passed between these components as shown in FIG. 26. Alternately, the message passing diagram shown in FIG. 26 may be used in conjunction with a different procedure.

In some implementations, a request to transfer funds from the smart card to the EGM may be received at the user interface 2012. The user interface 2012 may then transmit this request to the operating system 2006, which may forward the request to the card reader 2008. The card reader may generate a request identifier, as discussed with respect to FIG. 21, and transmit a message initiating the transfer to the gaming machine operating system 2006.

In some implementations, the operating system 2006 may then cause the user interface 2012 to display a message indicating that a transfer is occurring. The message may remain on the user interface 2012 while the transfer completes. When such a message is generated, the operating system may start a timer indicating a time period in which the message is displayed on the user interface 2012.

In some implementations, the operating system 2006 may deny the transfer for various reasons, such as an inadequate balance on the smart card or an invalid smart card. The operating system 2006 may transmit a message indicating that the request was denied to the card reader 2008. The operating system 2006 may also transmit a report of the transaction to the smart card host 2002, which may return an acknowledgment message.

In some implementations, the operating system 2006 may cause the transfer message displayed at the user interface 2012 to be replaced with a message indicating that the requested transfer has failed. When the new message is displayed, a new message duration timer may be started. Message duration timers may be employed in some implementations to ensure that each message displayed on the user interface 2012 is displayed for a period of time sufficient to allow the player to see the message. When the message duration timer has reached an appropriate value, the operating system 2006 may cause the user interface 2012 to stop displaying the message indicating that the requested transfer has failed.

FIGS. 14, 15A, and 15B show perspective diagrams of a gaming machine 2, configured in accordance with one implementation. As illustrated in FIGS. 14, 15A, and 15B, gaming machine 2 includes a main cabinet 4, which generally surrounds the machine interior and is viewable by users. The main cabinet includes a main door 8 on the front of the machine, which opens to provide access to the interior of the machine.

In some implementations, the electronic gaming machine may include any of a plurality of devices. For example, the electronic gaming machine may include a ticket printer that prints bar-coded tickets, a key pad for entering player tracking information, a display (e.g., a video display screen) for displaying player tracking information, a card reader for entering a magnetic striped card containing player tracking information, and any other devices. The ticket printer may be used to print tickets for a cashless ticketing system. In FIGS. 14, 15A, and 15B, attached to the main door is a payment acceptor 28, a bill validator 30, and a coin tray 38. The payment acceptor may include a coin slot and/or a payment, note, or bill acceptor, where the player inserts money, coins, tokens, or other types of payments.

In some implementations, devices such as readers or validators for credit cards, debit cards, smart cards, or credit slips may facilitate payment. For example, a player may insert an identification card into a card reader of the gaming machine. The identification card may be a smart card coded with a player's identification, credit totals (or related data) and other relevant information. As another example, a player may carry a portable device, such as a cell phone, a radio frequency identification tag or any other suitable wireless device. The portable device may communicates a player's identification, credit totals (or related data), and/or any other relevant information to the gaming machine. As yet another example, money may be transferred to a gaming machine through electronic funds transfer. When a player funds the gaming machine, a logic device coupled to the gaming machine may determine the amount of funds entered and display the corresponding amount on a display device.

In some implementations, attached to the main door is a plurality of player-input switches or buttons 32. The input switches can include any suitable devices which enables the player to produce an input signal which is received by the processor. The input switches may include a game activation device that may be used by the player to start any primary game or sequence of events in the gaming machine. The game activation device can be any suitable play activator such as a “bet one” button, a “max bet” button, or a “repeat the bet” button. In some instances, upon appropriate funding, the gaming machine may begin the game play automatically. Alternately, the gaming machine may automatically activate game play after detecting user input via the game activation device.

In some implementations, one input switch is a cash-out button. The player may push the cash-out button and cash out to receive a cash payment or other suitable form of payment corresponding to the number of remaining credits. For example, when the player cashes out, the player may receive the coins or tokens in a coin payout tray. As another example, the player may receive other payout mechanisms such as tickets or credit slips redeemable by a cashier (or other suitable redemption system) or funding to the player's electronically recordable identification card. As yet another example, funds may be transferred from the gaming machine to the player's smart card.

In some implementations, one input switch is a touch-screen coupled with a touch-screen controller, or some other touch-sensitive display overlay to enable for player interaction with the images on the display. The touch-screen and the touch-screen controller may be connected to a video controller. A player may make decisions and input signals into the gaming machine by touching the touch-screen at the appropriate places. One such input switch is a touch-screen button panel.

In some implementations, the gaming machine may include communication ports for enabling communication of the gaming machine processor with external peripherals, such as external video sources, expansion buses, game or other displays, a SATA port, a key pad, or a network interface for communicating via a network.

In some implementations, the electronic gaming machine may include one or more display devices. For example, the electronic gaming machine 2 includes a display device 34 and an information panel 36. The display device 34 and the information panel 36 may each include any of a cathode ray tube, an LCD, a light emitting diode (LED) based display, an organic light emitting diode (OLED) based display, a polymer light emitting diode (PLED) based display, an SED based-display, an E-ink display, a plasma display, a television display, a display including a projected and/or reflected image, or any other suitable electronic display device.

In some implementations, the display devices at the gaming machine may include one or more electromechanical devices such as one or more rotatable wheels, reels, or dice. The display device may include an electromechanical device adjacent to a video display, such as a video display positioned in front of a mechanical reel. The display devices may include dual-layered or multi-layered electromechanical and/or video displays that cooperate to generate one or more images. The display devices may include a mobile display device, such as a smart phone or tablet computer, that allows play of at least a portion of the primary or secondary game at a location remote from the gaming machine. The display devices may be of any suitable size and configuration, such as a square, a rectangle or an elongated rectangle.

In some implementations, the display devices of the gaming machine are configured to display game images or other suitable images. The images may include symbols, game indicia, people, characters, places, things, faces of cards, dice, and any other images. The images may include a visual representation or exhibition of the movement of objects such as mechanical, virtual, or video reels and wheel. The images may include a visual representation or exhibition of dynamic lighting, video images, or any other images.

In some implementations, the electronic gaming machine may include a top box. For example, the gaming machine 2 includes a top box 6, which sits on top of the main cabinet 4. The top box 6 may house any of a number of devices, which may be used to add features to a game being played on the gaming machine 2. These devices may include speakers 10 and 12, display device 45, and any other devices. Further, the top box 6 may house different or additional devices not illustrated in FIGS. 14, 15A, and 15B. For example, the top box may include a bonus wheel or a back-lit silk screened panel which may be used to add bonus features to the game being played on the gaming machine. As another example, the top box may include a display for a progressive jackpot offered on the gaming machine. As yet another example, the top box may include a smart card interaction device. During a game, these devices are controlled and powered, at least in part, by circuitry (e.g. a master gaming controller) housed within the main cabinet 4 of the machine 2.

In some implementations, speakers may be mounted and situated in the cabinet with an angled orientation toward the player. For instance, the speakers 10 and 12 located in top box area 6 of the upper region of gaming machine 2 may be mounted and situated in the cabinet with an angled orientation down towards the player and the floor. In one example, the angle is 45 degrees with respect to the vertical, longitudinal axis of machine 2. In another example, the angle is in a range of 30-60 degrees. In another example, the angle is any angle between 0 and 90 degrees. In some implementations, the angle of speakers in the gaming machine may be adjustable. For instance, speakers may be adjusted to face in a direction more closely approximating an estimated position of a player's head or facial features.

The bill validator 30, player-input switches 32, display screen 34, and other gaming devices may be used to present a game on the game machine 2. The devices may be controlled by code executed by a master gaming controller housed inside the main cabinet 4 of the machine 2. The master gaming controller may include one or more processors including general purpose and specialized processors, such as graphics cards, and one or more memory devices including volatile and non-volatile memory. The master gaming controller may periodically configure and/or authenticate the code executed on the gaming machine.

In some implementations, the gaming machine may include a sound generating device coupled to one or more sounds cards. The sound generating device may include one or more speakers or other sound generating hardware and/or software for generating sounds, such as playing music for the primary and/or secondary game or for other modes of the gaming machine, such as an attract mode. The gaming machine may provide dynamic sounds coupled with attractive multimedia images displayed on one or more of the display devices to provide an audio-visual representation or to otherwise display full-motion video with sound to attract players to the gaming machine. During idle periods, the gaming machine may display a sequence of audio and/or visual attraction messages to attract potential players to the gaming machine. The videos may also be customized for or to provide any appropriate information.

In some implementations, the gaming machine may include a sensor, such as a camera that is selectively positioned to acquire an image of a player actively using the gaming machine and/or the surrounding area of the gaming machine. The sensor may be configured to capture biometric data about a player in proximity to the gaming machine. The biometric data may be used to implement mechanical and/or digital adjustments to the gaming machine. Alternately, or additionally, the sensor may be configured to selectively acquire still or moving (e.g., video) images. The display devices may be configured to display the image acquired by the camera as well as display the visible manifestation of the game in split screen or picture-in-picture fashion. For example, the camera may acquire an image of the player and the processor may incorporate that image into the primary and/or secondary game as a game image, symbol, animated avatar, or game indicia.

Gaming machine 2 is but one example from a wide range of gaming machine designs on which the techniques described herein may be implemented. For example, not all suitable gaming machines have top boxes or player tracking features. Further, some gaming machines have only a single game display—mechanical or video, while others may have multiple displays.

FIG. 16 shows a server-based gaming network, configured in accordance with some implementations. Those of skill in the art will realize that this architecture and the related functionality are merely examples and that the present disclosure encompasses many other such implementations and methods.

Here, casino computer room 1620 and networked devices of a gaming establishment 1605 are illustrated. Gaming establishment 1605 is configured for communication with central system 1663 via gateway 1650. Gaming establishments 1693 and 1695 are also configured for communication with central system 1663.

In some implementations, gaming establishments may be configured for communication with one another. In this example, gaming establishments 1693 and 1695 are configured for communication with casino computer room 1620. Such a configuration may allow devices and/or operators in casino 1605 to communicate with and/or control devices in other casinos. In some such implementations, a server in computer room 1620 may control devices in casino 1605 and devices in other gaming establishments. Conversely, devices and/or operators in another gaming establishment may communicate with and/or control devices in casino 1605.

For example, a server of casino 1605 or central system 1663 may be provisioned with relatively more advanced software (e.g., 3-D facial recognition software) for patron identification than servers of other networked locations. Such a server may process patron identification requests from devices in casino 1605 as well as patron identification requests from devices in gaming establishments 1693 and 1695.

Here, gaming establishment 1697 is configured for communication with central system 1663, but is not configured for communication with other gaming establishments. Some gaming establishments (not shown) may not be in communication with other gaming establishments or with a central system. Gaming establishment 1605 includes multiple gaming machines 1621, each of which is part of a bank 1610 of gaming machines 1621. In this example, gaming establishment 1605 also includes a bank of networked gaming tables 1653. However, the present disclosure may be implemented in gaming establishments having any number of gaming machines, gaming tables, etc. It will be appreciated that many gaming establishments include hundreds or even thousands of gaming machines 1621 and/or gaming tables 1653, not all of which are necessarily included in a bank and some of which may not be connected to a network. At least some of gaming machines 1621 and/or mobile devices 1670 may be “thin clients” that are configured to perform client-side methods as described elsewhere herein.

Some configurations can provide automated, multi-player roulette, blackjack, baccarat, and other table games. The table games may be conducted by a dealer and/or by using some form of automation, which may include an automated roulette wheel, an electronic representation of a dealer, etc. In some such implementations, devices such as cameras, radio frequency identification devices, etc., may be used to identify and/or track playing cards, chips, etc. Some of gaming tables 1653 may be configured for communication with individual player terminals (not shown), which may be configured to accept bets, present an electronic representation of a dealer, indicate game outcomes, etc.

Gaming establishment 1605 also includes networked kiosks 1677. Depending on the implementation, kiosks 1677 may be used for various purposes, including but not limited to cashing out, prize redemption, redeeming points from a player loyalty program, redeeming “cashless” indicia such as bonus tickets, smart cards, etc. In some implementations, kiosks 1677 may be used for obtaining information about the gaming establishment, e.g., regarding scheduled events (such as tournaments, entertainment, etc.), regarding a patron's location, etc. Software related to such features may be provided and/or controlled, and related data may be obtained and/or provided, according to the present disclosure. For example, in some implementations of the disclosure, kiosks 1677 may be configured to receive information from a patron, e.g., by presenting graphical user interfaces.

In this example, each bank 1610 has a corresponding switch 1615, which may be a conventional bank switch in some implementations. Each switch 1615 is configured for communication with one or more devices in computer room 1620 via main network device 1625, which combines switching and routing functionality in this example. Although various communication protocols may be used, some preferred implementations use the Gaming Standards Association's G2S Message Protocol. Other implementations may use the open, Ethernet-based SuperSAS® protocol, which is available from IGT. Still other protocols, including but not limited to Best of Breed (“BOB”), may be used to implement various implementations of the disclosure. IGT has also developed a gaming-industry-specific transport layer called CASH that rides on top of TCP/IP and offers additional functionality and security.

Here, gaming establishment 1605 also includes an RFID network, implemented in part by RFID switches 1619 and multiple RFID readers 1617. An RFID network may be used, for example, to track objects (such as mobile gaming devices 1670, which include RFID tags 1627 in this example), patrons, etc., in the vicinity of gaming establishment 1605.

As noted elsewhere herein, some implementations of the disclosure may involve “smart” player loyalty instruments, such as player tracking cards, which include an RFID tag. Accordingly, the location of such RFID-enabled player loyalty instruments may be tracked via the RFID network. In this example, at least some of mobile devices 1670 may include an RFID tag 1627, which includes encoded identification information for the mobile device 1670. Accordingly, the locations of such tagged mobile devices 1670 may be tracked via the RFID network in gaming establishment 1605. Other location-detection devices and systems, such as the global positioning system (“GPS”), may be used to monitor the location of people and/or devices in the vicinity of gaming establishment 1605 or elsewhere.

Various alternative network topologies can be used to implement different implementations of the disclosure and/or to accommodate varying numbers of networked devices. For example, gaming establishments with large numbers of gaming machines 1621 may require multiple instances of some network devices (e.g., of main network device 1625, which combines switching and routing functionality in this example) and/or the inclusion of other network devices not shown in FIG. 16. Some implementations of the disclosure may include one or more middleware servers disposed between kiosks 1677, RFID switches 1619 and/or bank switches 1615 and one or more devices in computer room 1620 (e.g., a corresponding server). Such middleware servers can provide various useful functions, including but not limited to the filtering and/or aggregation of data received from switches, from individual gaming machines and from other devices. Some implementations of the disclosure include load-balancing methods and devices for managing network traffic.

Storage devices 1611, server 1630, License Manager 1631, Arbiter 1633, servers 1632, 1634, 1636 and 1638, host device(s) 1660 and main network device 1625 are disposed within computer room 1620 of gaming establishment 1605. In practice, more or fewer devices may be used. Depending on the implementation, some such devices may reside in gaming establishment 1605 or elsewhere.

One or more devices in central system 1663 may also be configured to perform, at least in part, tasks specific to the present disclosure. For example, one or more servers 1662, arbiter 1633, storage devices 1664 and/or host devices 1660 of central system 1663 may be configured to implement the functions described in detail elsewhere herein. These functions may include, but are not limited to, providing functionality for devices such as wager gaming machines 1621, mobile devices 1670, etc.

One or more of the servers of computer room 1620 may be configured with software for receiving a player's wager gaming notification parameters, determining when a wagering condition corresponds with the wager gaming notification parameters and/or providing a notification to the player when the wagering condition corresponds with the wager gaming notification parameters. Moreover, one or more of the servers may be configured to receive, process and/or provide image data from cameras 1609, to provide navigation data to patrons (e.g., to indicate the location of and/or directions to a gaming table, a wager gaming machine, etc., associated with a wager gaming notification), etc.

For example, navigation data (which may include map data, casino layout data, camera image data, etc.) may be provided by one or more of the servers of computer room 1620 to mobile devices 1670. Some implementations of the present disclosure include a plurality of networked cameras 1609, which may be video cameras, smart cameras, digital still cameras, etc. In some such implementations, such cameras may provide, at least in part, real-time navigation.

Other devices that may be deployed in network 1605 do not appear in FIG. 16. For example, some gaming networks may include not only various radio frequency identification (“RFID”) readers 1617, but also RFID switches, middleware servers, etc., some of which are not depicted in FIG. 16. These features may provide various functions. For example, a server (or another device) may determine a location of a mobile device 1670 according to the location of an RFID reader that reads an RFID tag 1627.

The servers and other devices indicated in FIG. 16 may be configured for communication with other devices in or outside of gaming establishment 1605, such as host devices 1660, kiosks 1677 and/or mobile devices 1670, for implementing some methods described elsewhere herein. Servers (or the like) may facilitate communications with such devices, receive and store patron data, provide appropriate responses, etc., as described elsewhere herein.

Some of these servers may be configured to perform tasks relating to accounting, player loyalty, bonusing/progressives, configuration of gaming machines, etc. One or more such devices may be used to implement a casino management system, such as the IGT Advantage™ Casino System suite of applications, which provides instantaneous information that may be used for decision-making by casino managers. A Radius server and/or a DHCP server may also be configured for communication with the gaming network. Some implementations of the disclosure provide one or more of these servers in the form of blade servers.

Some implementations of server 1630 and the other servers shown in FIG. 16 include (or are at least in communication with) clustered CPUs, redundant storage devices, including backup storage devices, switches, etc. Such storage devices may include a “RAID” (originally redundant array of inexpensive disks, now also known as redundant array of independent disks) array, back-up hard drives and/or tape drives, etc.

In some implementations of the disclosure, many of these devices (including but not limited to License Manager 1631, servers 1632, 1634, 1636, and 1638, and main network device 1625) are mounted in a single rack with server 1630. Accordingly, many or all such devices will sometimes be referenced in the aggregate as a “server-based gaming server.” However, in alternative implementations, one or more of these devices is in communication with server 1630 and/or other devices of the network but located elsewhere. For example, some of the devices could be mounted in separate racks within computer room 1620 or located elsewhere on the network. Moreover, it can be advantageous to store large volumes of data elsewhere via a storage area network (“SAN”).

Computer room 1620 may include one or more operator consoles or other host devices that are configured for communication with other devices within and outside of computer room 1620. Such host devices may be provided with software, hardware and/or firmware for implementing various implementations of the disclosure. However, such host devices need not be located within computer room 1620. Wired host devices 1660 (which are desktop and laptop computers in this example) and wireless devices 1670 (which are mobile computing devices in this example) may be located elsewhere in gaming establishment 1605 or at a remote location.

These and other aspects of the disclosure may be implemented by various types of hardware, software, firmware, etc. For example, some features of the disclosure may be implemented, at least in part, by machine-readable media that include program instructions, state information, etc., for performing various operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. An electronic gaming machine comprising:
a user input device configured to accept user input for conducting play of a wager-based game in which one or more game outcomes can be provided responsive to a wager;
a display configured to display data associated with the wager-based game;
one or more processors configured to cause the electronic gaming machine to:
identify, within an operating system running at an electronic gaming machine, a smart card interaction device coupled with the electronic gaming machine, the smart card interaction device capable of facilitating communication between the electronic gaming machine and a smart card in communication with the smart card interaction device;
initiate a communication protocol interface within the operating system, the communication protocol interface providing a mechanism for transmitting messages between the electronic gaming machine and devices in communication with the electronic gaming machine; and
transmit, via the communication protocol interface, a first message between the smart card interaction device and a first host server, the first host server being in communication with the electronic gaming machine via a network.

2. The electronic gaming machine recited in claim 1, the one or more processors further configured to cause the electronic gaming machine to:
transmit a second message from the electronic gaming machine operating system to a second host server via the communication protocol interface, the second message comprising a description of a capability of the gaming machine, the capability comprising communication between the electronic gaming machine and the smart card interaction device.

3. The electronic gaming machine recited in claim 2, the one or more processors further configured to cause the electronic gaming machine to:
receive a third message from the second host server at the electronic gaming machine operating system, the third message comprising an indication that at least a portion of communications received at the electronic gaming machine from the smart card interaction device is to be transmitted to the first host server.

4. The electronic gaming machine recited in claim 2, the one or more processors further configured to cause the electronic gaming machine to:
determine status information for the smart card interaction device, the status information comprising an indication of an operating status of the smart card interaction device, wherein the second message further comprises the indication of the operating status.

5. The electronic gaming machine recited in claim 1, the one or more processors further configured to cause the electronic gaming machine to:
load a first smart card device driver within the operating system, the first smart card device driver specifying a protocol for communication between the electronic gaming machine operating system and the smart card interaction device.

6. The electronic gaming machine recited in claim 1, wherein the electronic gaming machine is capable of adjusting a credit meter at the electronic gaming machine based on communication with the smart card interaction device, the credit meter specifying a number of credits available for use in wager-based gaming at the electronic gaming machine.

7. The electronic gaming machine recited in claim 1, wherein initiating the communication protocol interface comprises:
initiating an extension class to the communication protocol interface, the extension class providing access to smart card messaging procedures not included in the base communication protocol interface.

8. A method of activating a smart card interaction device, the method comprising:
identifying, within an operating system running at an electronic gaming machine, a smart card interaction device coupled with the electronic gaming machine, the smart card interaction device capable of facilitating communication between the electronic gaming machine and a smart card in communication with the smart card interaction device;
initiating a communication protocol interface within the operating system, the communication protocol interface providing a mechanism for transmitting messages between the electronic gaming machine and devices in communication with the electronic gaming machine; and
transmitting, via the communication protocol interface, a first message between the smart card interaction device and a first host server, the first host server being in communication with the electronic gaming machine via a network.

9. The method recited in claim 8, the method further comprising:
transmitting a second message from the electronic gaming machine operating system to a second host server via the communication protocol interface, the second message comprising a description of a capability of the gaming machine, the capability comprising communication between the electronic gaming machine and the smart card interaction device.

10. The method recited in claim 9, the method further comprising:
receiving a third message from the second host server at the electronic gaming machine operating system, the third message comprising an indication that at least a portion of communications received at the electronic gaming machine from the smart card interaction device is to be transmitted to the first host server.

11. The method recited in claim 9, the method further comprising:
determining status information for the smart card interaction device, the status information comprising an indication of an operating status of the smart card interaction device, wherein the second message further comprises the indication of the operating status.

12. The method recited in claim 8, the method further comprising:
loading a first smart card device driver within the operating system, the first smart card device driver specifying a protocol for communication between the electronic gaming machine operating system and the smart card interaction device.

13. The method recited in claim 8, wherein the electronic gaming machine is capable of adjusting a credit meter at the electronic gaming machine based on communication with the smart card interaction device, the credit meter specifying a number of credits available for use in wager-based gaming at the electronic gaming machine.

14. The method recited in claim 9, wherein initiating the communication protocol interface comprises:
initiating an extension class to the communication protocol interface, the extension class providing access to smart card messaging procedures not included in the base communication protocol interface.

15. One or more computer readable media having instructions stored thereon for performing a method of activating a smart card interaction device, the method comprising:
identifying, within an operating system running at an electronic gaming machine, a smart card interaction device coupled with the electronic gaming machine, the smart card interaction device capable of facilitating communication between the electronic gaming machine and a smart card in communication with the smart card interaction device;
initiating a communication protocol interface within the operating system, the communication protocol interface providing a mechanism for transmitting messages between the electronic gaming machine and devices in communication with the electronic gaming machine; and
transmitting, via the communication protocol interface, a first message between the smart card interaction device and a first host server, the first host server being in communication with the electronic gaming machine via a network.

16. The one or more computer readable media recited in claim 15, the method further comprising:
transmitting a second message from the electronic gaming machine operating system to a second host server via the communication protocol interface, the second message comprising a description of a capability of the gaming machine, the capability comprising communication between the electronic gaming machine and the smart card interaction device.

17. The one or more computer readable media recited in claim 16, the method further comprising:
receiving a third message from the second host server at the electronic gaming machine operating system, the third message comprising an indication that at least a portion of communications received at the electronic gaming machine from the smart card interaction device is to be transmitted to the first host server.

18. The one or more computer readable media recited in claim 16, the method further comprising:
determining status information for the smart card interaction device, the status information comprising an indication of an operating status of the smart card interaction device, wherein the second message further comprises the indication of the operating status.

19. The one or more computer readable media recited in claim 15, the method further comprising:
loading a first smart card device driver within the operating system, the first smart card device driver specifying a protocol for communication between the electronic gaming machine operating system and the smart card interaction device.

20. The one or more computer readable media recited in claim 15, wherein the electronic gaming machine is capable of adjusting a credit meter at the electronic gaming machine based on communication with the smart card interaction device, the credit meter specifying a number of credits available for use in wager-based gaming at the electronic gaming machine.
